(19) United States
(12) Patent Application Publication
(10) Pub. No.: US 2015/0237598 A1
(43) Pub. Date: Aug. 20, 2015

(54) INFORMATION NOTIFICATION DEVICE AND INFORMATION NOTIFICATION METHOD, AND INFORMATION RECEPTION DEVICE AND INFORMATION RECEPTION METHOD

(71) Applicant: SONY CORPORATION, TOKYO (JP)

(72) Inventors: KOSUKE YOSHITOMI, KANAGAWA (JP); KUNIAKI TORII, KANAGAWA (JP); KATSUYA HYODO, KANAGAWA (JP); HIKOTATSU CHIN, TOKYO (JP)

(21) Appl. No.: 14/618,145

(22) Filed: Feb. 10, 2015

(30) Foreign Application Priority Data
Feb. 19, 2014 (JP) 2014-029485

(51) Int. Cl. H04W 68/02; H04W 4/12

(52) U.S. Cl. CPC H04W 68/02; H04W 4/12

(57) ABSTRACT

An information notification device includes an equipment management unit that manages a plurality of pieces of equipment which are in a vicinity of a user, and a function execution unit that executes transmission of notification information to any one of the plurality of pieces of equipment by determining a notification strategy that will perform notification of notification information to a user.

### CROSS REFERENCE TO RELATED APPLICATIONS

This application claims the benefit of Japanese Priority Patent Application JP 2014-029485 filed Feb. 19, 2014, the entire contents of which are incorporated herein by reference.

### BACKGROUND

The technology that is disclosed in the embodiments of the present specification relates to an information notification device and an information notification method that perform notification to a user of various items of notification information such as a notification from a schedule reminder or a service that a user has registered or a notification of emergency information, and an information reception device and an information reception method that receive notification information and present the notification information to a user.

The notification of various information such as a notification from a schedule reminder or a service that a user has registered or a notification of emergency information is performed through an information terminal such as a mobile telephone or smartphone, a tablet or personal computer, which is provided with a communication function. Year after year there is a tendency for an increase in the services and applications that use notifications.

Generally, among information that is conveyed by notifications, there is a great deal of information that has high immediacy. Therefore, various designs have been devised so that a user that receives a notification does not overlook them. For example, in notifications that use a mobile telephone, it is configured so that a user realizes that there is a notification even if the user is not observing the screen of the equipment by performing a notification with sound or vibration in addition to performing a notification on the screen.

For example, a mobile terminal that performs a notification to the effect that an urgent email has been received every scheduled period of time, which has been set in advance, in an intervening period until a confirmation manipulation has been carried out for the urgent email by an urgent email being received from an external terminal, a main display displaying the urgent email that was received, and a control unit performing a notification to the effect that an urgent email has been received using a vibrator or speaker, a light emitting element, or the like, has been suggested (for example, refer to Japanese Unexamined Patent Application Publication No. 2009-278560).

In addition, a mobile terminal device that, when there is an incoming item of character information communication (an email), is capable of determining an urgency through a search of a title, and keywords in a main body of the email, and acquiring sender information, performing an incoming notification to a user using an incoming item tone setting and a vibrator operation setting that have been set in advance for the keywords and sender information, and forcing sounding of an incoming item tone for incoming email with a high order of priority even when in a silent mode, has been suggested (for example, refer to Japanese Unexamined Patent Application Publication No. 2008-217731).

In addition, there are cases in which designs that reduce a circumstance in which a user overlooks a notification by concurrently performing a notification on pieces of equipment on which a user is logged in, thereby increasing the chance of attracting the attention of the user, have been devised.

For example, an incoming item notification system that simultaneously reports an incoming item notification to pieces of equipment that are in the vicinity when an incoming item is established on a mobile terminal, and determines an output method of the incoming item notifications by selecting or refusing the incoming item notification on a side of the piece of equipment that received the incoming item notification (for example, refer to Japanese Unexamined Patent Application Publication No. 2005-117284).

### SUMMARY

It is desirable to provide an excellent information notification device and an information notification method that can suitably perform notification to a user of various items of notification information such as a notification from a schedule reminder or a service that a user has registered or a notification of emergency information, the urgency and the importance of which differ.

It is also desirable to provide an information reception device and an excellent information reception method that can suitably receive various items of notification information, the urgency and the importance of which differ, and present the notification information to a user.

According to an embodiment of the present disclosure, there is provided an information notification device that includes an equipment management unit that manages a plurality of pieces of equipment which are in a vicinity of a user, and a function execution unit that executes transmission of notification information to any one of the plurality of pieces of equipment by determining a notification strategy that will perform notification of notification information to a user.

In the information notification device, the function execution unit may determine a notification strategy that relates to a notification target piece of equipment of notification information or a notification method of notification information to a piece of equipment on the basis of at least one of characteristics of notification information or respective characteristics of the plurality of pieces of equipment.

In the information notification device, the function execution unit may determine a notification strategy that is formed from at least one of a priority of pieces of equipment that are to be transmission targets of notification information, a notification range of notification information, a re-notification target in a case in which notification information is unread, and a number of times of re-notification.

The information notification device may further include an action management unit that manages positional information of a user or actions of a user. Further, the function execution unit may set a transmission target of notification information depending on positional information of a user or actions of a user.

The information notification device may further include a companion management unit that manages information of a companion that is acting with a user. Further, the equipment management unit may further manage a piece of equipment that a companion is carrying or wearing, and the function execution unit may determine a notification target or a re-notification target of notification information from two or more pieces of equipment that include a piece of equipment that a user is carrying or wearing, and a piece of equipment that a companion is carrying or wearing according to a notification strategy.

In the information notification device, the equipment management unit may further manage a piece of equipment that is used by a large number of people, a piece of equipment that is shared with users in the vicinity, or a piece of equipment that is installed in a communal location, and the function execution unit may determine a notification target or a re-notification target of notification information from two or more pieces of equipment that include a piece of equipment that a user is carrying or wearing, a piece of equipment that is used by a large number of people, a piece of equipment that is shared with users in the vicinity, or a piece of equipment that is installed in a communal location.

In the information notification device, the function execution unit may set any one of a piece of equipment that is used by a large number of people, a piece of equipment that is shared with users in the vicinity, or a piece of equipment that is installed in a communal location as a re-notification target of notification information in a case in which notification information that was transmitted to a piece of equipment that is in the possession of a user is unread.

In the information notification device, the function execution unit may perform notification or re-notification of notification information to any one of a piece of equipment that is used by a large number of people, a piece of equipment that is shared with users in the vicinity, or a piece of equipment that is installed in a communal location within a range or a notification method that an urgency, an importance or another characteristic of the notification information allows.

The information notification device may further include a notification management unit that manages a notification state of notification information to a piece of equipment. Further, the function execution unit may perform re-notification of notification information or a notification information process on the basis of a notification state that the notification management unit manages and a notification strategy.

In the information notification device, the function execution unit may also perform re-notification of notification information that is in an unread state on the basis of a notification strategy on any piece of equipment to which notification or re-notification has been performed.

In the information notification device, the function execution unit may delete notification information that has attained an already read state from any piece of equipment to which notification or re-notification has been performed.

In the information notification device, when notification information has attained a read state on any piece of equipment to which notification or re-notification has been performed, the function execution unit may also set an read state on other pieces of equipment that have an unread state.

In the information notification device, the function execution unit may transmit first notification information when a user comes within a certain range of a destination, and may transmit second notification information when a user gets closer to a destination.

In the information notification device, the function execution unit may set a piece of equipment that is used by a large number of people that is in the vicinity of a user, or a piece of equipment that is shared with users in the vicinity as a re-notification target of notification information in a case in which notification information that has been transmitted to a piece of equipment that a user owns is unread.

In the information notification device, the function execution unit may set a piece of equipment that a companion owns as a re-notification target of notification information in a case in which notification information that has been transmitted to a piece of equipment that a user owns is unread.

According to another embodiment of the present disclosure, there is provided an information notification method that includes managing a plurality of pieces of equipment which are in a vicinity of a user, and executing transmission of notification information to any one of the plurality of pieces of equipment by determining a notification strategy that will perform notification of notification information to a user.

According to still another embodiment of the present disclosure, there is provided an information reception device that includes a data output unit, and a function execution unit that outputs notification information that is received from an information notification device from the data output unit using a notification method that depends on characteristics of notification information or characteristics of the corresponding information reception device itself.

The information reception device may further include an action recognition unit that recognizes an action state of a user that owns the corresponding information reception device. Further, the function execution unit may output notification information from the data output unit using a notification method that corresponds to a recognition result of the action recognition unit.

The information reception device may further include a user recognition unit that recognizes a user that owns the corresponding information reception device or a user that is in a vicinity of the corresponding information reception device. Further, the function execution unit may output notification information from the data output unit using a notification method that depends on a recognition result of the user recognition unit.

According to still another embodiment of the present disclosure, there is provided an information reception method that includes receiving notification information from an information notification device, and outputting notification information from the information reception device using a notification method that depends on characteristics of notification information or characteristics of the information reception device.

According to the technology that is disclosed in the embodiments of the present specification, it is possible to suitably perform notification to a user of notification information by switching a notification target piece of equipment or a notification method depending on an importance and a secrecy of notification information and an equipment configuration that is in the vicinity of a notification target user, and therefore, it is possible to provide an excellent information notification device and information notification method.

In addition, according to the technology that is disclosed in the embodiments of the present specification, it is possible to present notification information to a user using a suitable method that depends on an importance and a secrecy of received notification information, and therefore, it is possible to provide an excellent information reception device and information reception method.

Additionally, the effects of the embodiments of the present specification are merely examples, and the effects of the embodiments of the present disclosure are not limited thereto. There are also cases in which the embodiments of the present disclosure further exhibit additional effects other than those mentioned above.

Other objects, features and advantages of the technology that is disclosed in the embodiments of the present disclosure will be elucidated using a detailed description that is based on the embodiments that are mentioned below and the appended drawings.

### BRIEF DESCRIPTION OF THE DRAWINGS

FIG. 1 is a view that schematically shows a configuration example of an information notification system in which the technology disclosed in embodiments of the present specification has been adopted.

FIG. 2 is a view that schematically shows a functional configuration of a service provision device.

FIG. 3 is a view that schematically shows a functional configuration of an information notification device.

FIG. 4 is a view that schematically shows a functional configuration of an information reception device.

FIG. 5 is a view for describing a flow of processes that perform notification of notification information in the information notification system according to a notification strategy.

FIG. 6 is a view that shows an information reception device displaying actual notification information.

FIG. 7 is a view that shows an information reception device displaying information that indicates presence of notification.

FIG. 8 is a view that shows a situation in which a message is displayed on a smartphone when a user enters a certain range of a destination.

FIG. 9 is a view that shows a situation in which a message is displayed on a glasses-type terminal when a user arrives in the general area of a destination.

FIG. 10 is a view that shows a flow of processes that perform notification of notification information in the information notification system according to a notification strategy that depends on a distance from a user to a specific location.

FIG. 11 is a view that shows a mobile telephone displaying notification information, the mobile telephone having been left in a bedroom.

FIG. 12 is a view that shows a situation in which a television that is placed in a living room where the user is displays information that indicates presence of notification.

FIG. 13 is a view that shows a shared tablet terminal displaying a summary of notification information to a user.

FIG. 14 is a flowchart that shows a process sequence for controlling a display method of received notification information in each information reception device.

FIG. 15 is a view that shows a mobile telephone of a notification target user A, which displays information indicating that it is approaching a time to take medicine.

FIG. 16 is a view that shows a glasses-type terminal worn by a user B who is accompanying a user A, the glasses-type terminal displaying notification information that is intended for the user A.

### DETAILED DESCRIPTION OF EMBODIMENTS

Hereinafter, embodiments of the technology that is disclosed in the present specification will be described in detail while referring to the drawings.

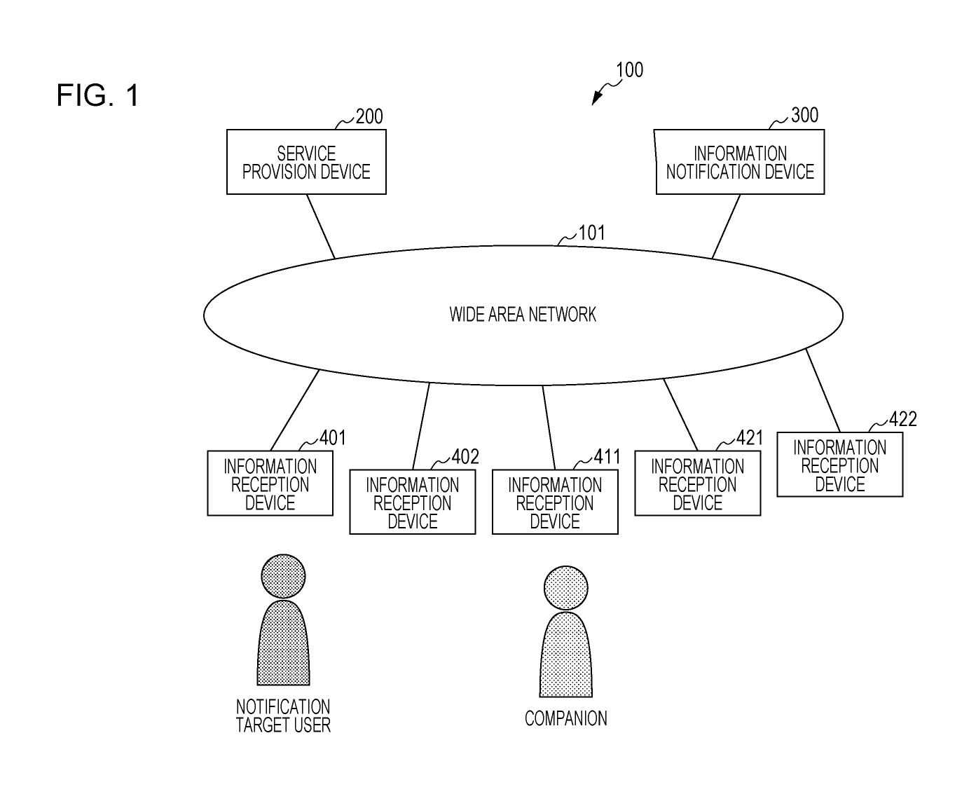

FIG. 1 is a view that schematically shows a configuration example of an information notification system 100 in which the technology that is disclosed in the embodiments of the present specification has been adopted.

An information notification system 100 that is illustrated in the drawing is configured by a service provision device 200, an information notification device 300, a plurality of information reception device 401 . . . . The service provision device 200, the information notification device 300, the information reception device 401 . . . are mutually connected via a wide area network 101 such as the Internet or a mobile telephone network. However, message exchange is possible between the service provision device 200 and the information notification device 300, and the information notification device 300 and each information reception device 401 . . . , but it is not necessarily demanded that message exchange be possible between the service provision device 200 and each information reception device 401.

The service provision device 200 provides notification information such as a notification from a schedule reminder or a service that a user has registered, or a notification of emergency information that is intended for each user. The characteristics that the service provision device 200 provides such as a secrecy and an urgency, an importance or a priority of notification information are diverse. The service provision device 200 is configured by a combination of a server that is constructed on the Internet and a plurality of servers, for example.

The information notification device 300 determines information reception devices that are to be transmission targets of notification information that the service provision device 200 provides and transmits the notification information. The information notification device 300 is configured by a combination of a server that is constructed on the Internet and a plurality of servers, for example. In addition, a single server may simultaneously serve as both the service provision device 200 and the information notification device 300.

As mentioned above, the characteristics of notification information such as a secrecy and an urgency, an importance or a priority are diverse. In addition, as will be described later, the characteristics (the effects on a user themselves and users in the vicinity of presenting notification information) of each information reception device 401 . . . such as being worn on the body of a user, being in the possession of a user due to insertion into a bag, being shared with other users, or being held by users in the vicinity are diverse.

In the present embodiment, the information notification device 300 determines a notification strategy such as a priority and a notification range of information reception devices that are to be transmission targets of notification information, a re-notification target in a case in which notification information is unread, and a number of times of re-notification, and determines information reception devices that are to be transmission targets of notification information according to the notification strategy on the basis of the characteristics of notification information that is to be transmitted and the characteristics of each information reception device 401 . . . that is in a vicinity of a user that is a notification target.

Each information reception device 401 . . . is an assembly of equipment that is in the vicinity of a user that is to be a notification target of notification information. Other than being carried or worn by a user, examples of the vicinity of a user include being in a private or communal location where a user currently is, being carried or worn by a companion that is acting with a user or the like. Examples of the information reception device 401 . . . are illustrated below. The effects (the urgency of a notification and the securing of certainty, the loss of secrecy and the like) on a user themselves and users in the vicinity of presenting notification information are diverse depending on the manner in which the information reception device 401 is in the vicinity of a user.

Reference numeral 401 is an information reception device such as a wearable terminal that a user is wears on the body thereof such as a glasses-type terminal (refer to Japanese Unexamined Patent Application Publication No. 2012-138654). If notification information is presented with the information reception device 401, the user themselves does not miss the notification information, and therefore, the urgency is high, and it is possible to deliver important notification information to a user without fail. Meanwhile, if low urgency notification information that is not very important is presented, it will become troublesome for the user by obstructing the view thereof.

Reference numeral 402 is an information reception device that a user does not directly attach to the body thereof, but normally is in possession of on a continuous basis such as a mobile telephone or a smartphone, or a tablet terminal. If notification information is presented with the information reception device 402 using a tone or oscillation (vibration), in the same manner as the information reception device 401 that a user is wearing on the body thereof, it is easy to convey the notification information to a user. However, if the information reception device 402 is shut away in a bag, it is possible that a user will not be aware of notifications, or will ignore notifications.

Reference numeral 411 is an information reception device that a companion that acts with a user is carrying or wearing rather than a user that is a notification target of notification information themselves. It is possible for a user to obtain notification information that is intended for themselves through the information reception device 411 of a companion even if the user is not wearing the information reception device 401 on the body thereof, and in addition, is not carrying the information reception device 402. However, a companion views the information reception device 411, and therefore, the content of a user's notification information will be known to the companion, but it is also possible to alert the attention of the companion to the notification information.

Reference numeral 421 is an information reception device that is shared with users in the vicinity such as a television that is installed in a living room inside a home or another consumer electronics (CE) item. It is possible for a user to obtain notification information that is intended for themselves from an information reception device 421 that is installed in a room that the user is in even if the user is not wearing the information reception device 401 on the body thereof, and in addition, is not carrying the information reception device 402. Users in the vicinity that are at the same location view the information reception device 421, and therefore, the content of the user's notification information will be known to the users, but since this is limited to being between family members or the like, it is thought that there is little problem even with notification information with a comparatively high secrecy.

Reference numeral 422 is an information reception device that is installed in a communal place such as digital signage or the like (configured as a communal facility). It is possible for a user to obtain notification information that is intended for themselves from the information reception device 422 even if the user is not wearing the information reception device 401 on the body thereof, is not carrying the information reception device 402 and in addition, is outdoors without a companion. If the information reception device 422 is used, it is possible to deliver notification information to a user regardless of location. However, since the information reception device 422 is installed in a communal place, and notification information that is presented will attract the attention of an unspecified large number of users, it is useful to present emergency information such as disaster warning information, but there is a problem from a viewpoint of protecting privacy if notification information with high secrecy is presented.

It can be understood that a range of public exposure, that is, the secrecy of notification information that is displayed on each information reception device 401 . . . that is in the vicinity of a user is diverse.

In the information notification system 100, if notification of notification information that is provided from the service provision device 200 is performed concurrently on all of the information reception devices 401 . . . , a chance of attracting the attention of a user increases, and therefore, a risk that the notification information will be missed is reduced. However, although it is possible to secure urgency of the notification information and certainty of notification, since the content of the notification information is well-known to users other than a user that is a notification target themselves, it is no longer possible to maintain the secrecy of a notification information with high secrecy. In addition, if concurrent notification is even performed for notification information with low importance, important notification information will be buried in with other notification information, and therefore, there is a concern that, conversely, important notification information will be missed.

In such an instance, in the present embodiment, the information notification device 300 is configured to determine a notification strategy on the basis of the characteristics of each information reception device 401 . . . that is in the vicinity of a notification target user and the characteristics of notification information that is to be transmitted, and determine information reception devices that are to be transmission targets of notification information according to the notification strategy. The notification strategy includes a priority order of information reception devices that are to be transmission targets of notification information, a notification order and a notification range of a re-notification target or the like in a case in which notification information is unread, a number of times of re-notification and the like.

The information notification device 300 sets a transmission target of notification information with high urgency, high importance and high secrecy to the information reception device 401 that a user that is a notification target is wearing. In addition, the information notification device 300 sets a transmission target of notification information, the urgency and the importance of which are not very high, to the information reception device 402 that a user that is a notification target is in possession of. In addition, the information notification device 300 sets the information reception device 411 that a companion is in possession of or the information reception device 421 that is in the vicinity as the transmission target of notification information with a range in which the secrecy and the like thereof will be secured when a user does not have the information reception device 401 or the information reception device 402 to hand. In addition, the information notification device 300 sets a transmission target of notification information with low secrecy to the information reception device 422 that is installed in a communal place.

Configurations of each device of the information notification system 100 for realizing a notification process of notification information according to a notification strategy will be described below.

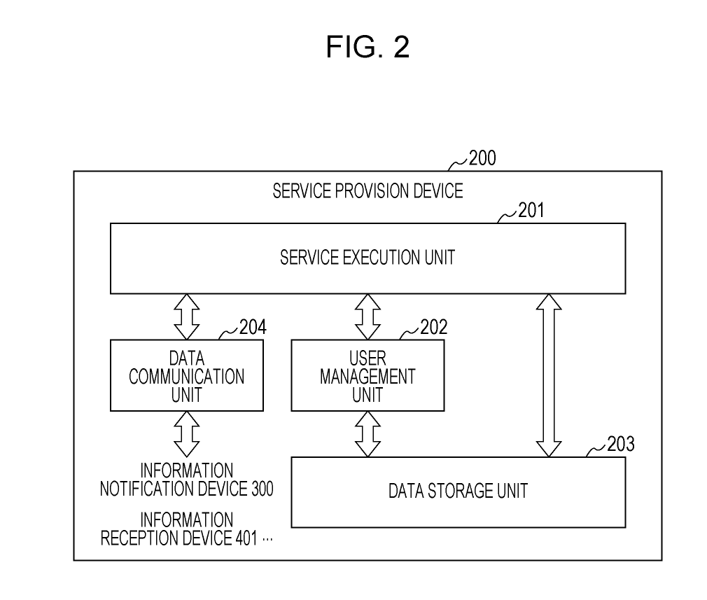

FIG. 2 schematically shows a functional configuration of the service provision device 200. The service provision device 200 that is illustrated in the drawing is provided with a service execution unit 201, a user management unit 202, a data storage unit 203 and a data communication unit 204.

The data storage unit 203 stores information that is necessary in the provision service of notification information such as a notification from a schedule reminder or recommended information, or a notification of emergency information. The user management unit 202 manages information that is registered for each user.

When it is detected that an event that will become an impetus for performing notification of notification information to a user has occurred, the service execution unit 201 creates notification information while referring to information that is stored in the data storage unit 203 on the basis of information of each user that is managed by the user management unit 202. Created notification information is transmitted to the information notification device 300 from the data communication unit 204 via the wide area network 101. It is possible to include recommended information, emergency information, a notification service of positional information or a notification service of a timetable as examples of services that are provided by the service execution unit 201.

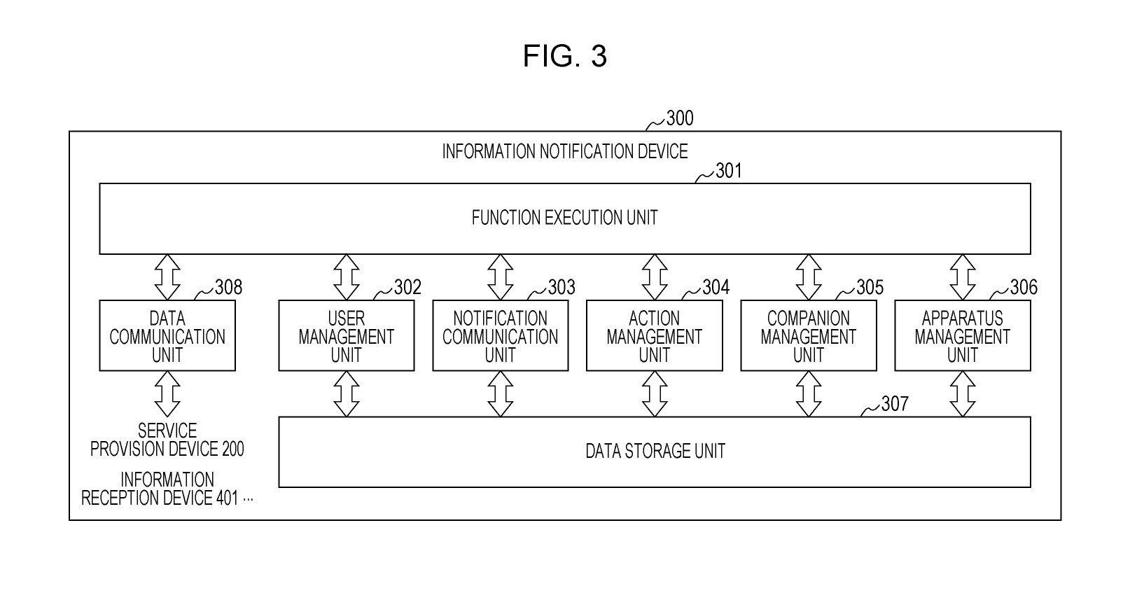

FIG. 3 schematically shows a functional configuration of the information notification device 300. The information notification device 300 executes a notification process of notification information by determining information reception devices that are to be notification targets of notification information and a notification strategy when notification information is received from the service provision device 200. The information notification device 300 that is illustrated in the drawing is provided with a function execution unit 301, a user management unit 302, a notification management unit 303, an action management unit 304, a companion management unit 305, an equipment management unit 306, a data storage unit 307 and a data communication unit 308.

The user management unit 302 manages user information of each user that uses a provision service of notification information using the service provision device 200. It is possible to include identification information of a user, access information such as an email address, personal information such as age and sex, or occupation and the like as examples of user information.

The equipment management unit 306 manages information of pieces of equipment that are in the vicinity of each user that is managed by the user management unit 302. The pieces of equipment that are in the vicinity of a user include the information reception device 401 that a user is wearing on the body thereof and the information reception device 402 that a user is in possession of, the information reception device 411 that a companion of a user carrying or wearing, the information reception device 421 that is shared a large number of people or with users in the vicinity, and the information reception device 422 that is installed in a communal place (to be described later).

The notification management unit 303 manages information reception devices that are to be transmission targets of notification information that is provided from the service provision device 200. In addition, the notification management unit 303 manages a reception state of notification information in each information reception device 401 . . . that is to be a transmission target. The function execution unit 301 executes re-notification of notification information, deletion of notification information and the like on the basis of information that is managed by the notification management unit 303.

The action management unit 304 manages actions such a position of a user on the basis of positional information and equipment information of information reception devices of a user, and schedule information of a user or the like.

The companion management unit 305 manages information of a companion that is acting with a user. The companion management unit 305 may specify a companion on the basis of positional information of information reception devices of each user, or may determine a companion of a user by taking personal information of a user or social graph information between users into consideration.

The user management unit 302, the notification management unit 303, the action management unit 304, the companion management unit 305 and the equipment management unit 306 store information that is necessary in order to realize the respective management functions thereof in the data storage unit 307, and refer to the data storage unit 307 as appropriate.

As will be described later, notification of information of a recognition result of an action of a user and information of a recognition result of a user from each information reception device 401 . . . is performed via the wide area network 101. Information for which notification is performed from each information reception device 401 . . . is stored in the data storage unit 307. In addition, the action management unit 304 and the companion management unit 305 can realize their respective functions by aggregating the recognition result of an action of a user and a recognition result of a user which notification is performed.

Further, in addition to being disposed inside a single piece of equipment that configures the information notification device 300, a portion of or all of the functions of the action management unit 304 and the companion management unit 305 may be assigned to physically separate devices that are installed on the wide area network 101.

The function execution unit 301 is provided with a function that executes a service that performs notification of notification information from the data communication unit 308 to a user via the wide area network 101.

In the present embodiment, the function execution unit 301 operates the user management unit 302, the notification management unit 303, the action management unit 304, the companion management unit 305, and the equipment management unit 306 in a cooperative manner, and the information notification device 300 determines a notification strategy such as a notification range of information reception devices that are to be transmission targets of notification information, a re-notification target in a case in which notification information is unread and the like and a number of times of re-notification on the basis of the characteristics of notification information that is to be transmitted and the characteristics of each information reception device 401 . . . that is in the vicinity of a user that is a notification target, sets information reception devices that are to be transmission targets of notification information according to the notification strategy, and performs notification of notification information to a user.

The notification strategy is a method that selects pieces of equipment that are to be notification targets or re-notification targets of notification information, a notification method of notification information or the like. The notification strategy includes a priority order of information reception devices that are to be transmission targets of notification information, a notification order and a notification range of a re-notification target or the like in a case in which notification information is unread, a number of times of re-notification and the like. In addition, the function execution unit 301 executes re-notification of notification information, deletion of notification information and the like on the basis of a reception state of notification information that is managed by the notification management unit 303.

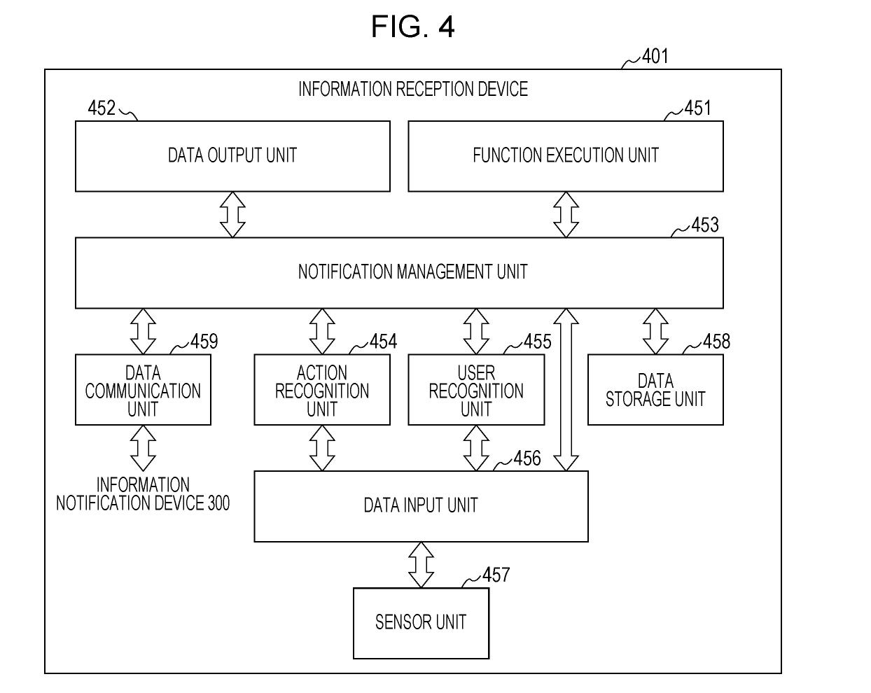

FIG. 4 schematically shows a functional configuration of the information reception device 401. It should be understood that the other information reception devices 402 . . . , which are not illustrated in the drawings, are also provided with the same functional configuration. The information reception device 401 that is illustrated in the drawing is provided with a function execution unit 451, a data output unit 452, a notification management unit 453, an action recognition unit 454, a user recognition unit 455, a data input unit 456, a sensor unit 457, a data storage unit 458 and a data communication unit 459.

The sensor unit 457 is, for example, provided with a combination of one or two or more sensors such as a gyro sensor or an acceleration sensor, a geomagnetic sensor, a GPS (Global Positioning System) sensor, a doppler sensor, an infrared sensor, or a wave intensity sensor, and acquires detection signals that relate to the position and posture of a user that is wearing the information reception device 401 main body or the corresponding device on the body thereof. In addition, in a case in which the information reception device 401 is a type of equipment that is used by being worn on the body of a user in the manner of a wearable terminal, the sensor unit 457 is also provided with a sensor that detects a wearing state. In addition to being built into the information reception device 401 main body, there are also cases in which the sensor unit 457 is attached to the information reception device 401 main body externally in the manner of an accessory component. The detection signals from the sensor unit 457 are taken through the data input unit 456.

The action recognition unit 454 recognizes a user that is wearing the information reception device 401, or an action state of a user that is in the vicinity of the information reception device 401 on the basis of sensor information that is taken in through the data input unit 456, and conveys a recognition result to the function execution unit 451 and the notification management unit 453 as user attribute information. States of walking, sitting operating the information reception device 401 and the like are included in the action states of a user. In addition, the action recognition unit 454 recognizes a direction in which a user's face is turned toward (an angle) and a direction of a line of sight (whether or not the corresponding device is being viewed) on the basis of facial recognition and line of sight recognition of images of a user that are captured with a camera, and conveys a recognition result to the function execution unit 451 and the notification management unit 453 as user attribute information.

The user recognition unit 455 recognizes a user that is wearing or in possession of the information reception device 401, or a user that is in the vicinity of the information reception device 401 (including a companion) on the basis of sensor information that is taken in through the data input unit 456, and conveys a recognition result to the function execution unit 451 and the notification management unit 453 as user attribute information. For example, an attempt to recognize a user may be made using a method of reading facial recognition of a captured image of a camera, sound recognition of a voice of a user and identification information that is stored in an IC tag that a user has attached to the body thereof, or the like. The user attribute information of a recognized user may be transmitted as digital information of user identification information or the like.

Additionally, in addition to being disposed inside the information reception device 401, a portion of or all of the functions of the action recognition unit 454 and the user recognition unit 455 may be assigned to devices that are network connected.

The data communication unit 459 performs data communication with the information notification device 300 via the wide area network 101. The notification management unit 453 transmits recognition results of the action recognition unit 454 and the user recognition unit 455 to the information notification device 300 from the data communication unit 459 as user attribute information of a corresponding user. For example, the notification management unit 453 may be configured to transmit recognition results to the information notification device 300 every predetermined period, or may be configured to transmit recognition results to the information notification device 300 in a case in which a change has occurred in the actions of a recognized user or user attribute information of a user that is in front of the information reception device 401.

In addition, the data communication unit 459 receives notification information that is intended for a user that is wearing the information reception device 401 or a user that is in the vicinity thereof from the information notification device 300.

The data output unit 452 configured by a combination of one or two or more output devices such as a display devices like a bitmap display and an LED (Light Emitting Diode) display, an acoustic device such as a speaker or a buzzer, or vibration.

The function execution unit 451 executes functions that are associated with notification information that is sent from the information notification device 300. More specifically, the function execution unit 451 performs notification to a user that is wearing the information reception device 401 or is in the vicinity thereof by outputting received notification information from the data output unit 452. The function execution unit 451 may process notification information (to be described later) when the outputting from the data output unit 452. In addition, the function execution unit 451 may be configured to output notification information from the data output unit 452 using a notification method that depends on a recognition result of actions of a user from the action recognition unit 454 or a recognition result of a user that the user recognition unit 455 has recognized.

In addition, the function execution unit 451 may be configured to select an output device that is used in the output of notification information, and determine an expression method of notification information on the basis of a recognition result in the action recognition unit 454 of actions of a notification target user or a recognition result in the user recognition unit 455 of a notification target user. For example, when the notification target user approaches a specific location (including in a case of becoming a notification target due to a user approaching a specific location), the function execution unit 451 loading a web browser and displaying information that relates to the corresponding location can be given as an example. In addition, the function execution unit 451 may be configured to associate and register software that is created to correspond to a kind of notification information. As a result of this configuration, it becomes possible to add a function that corresponds to new notification information.

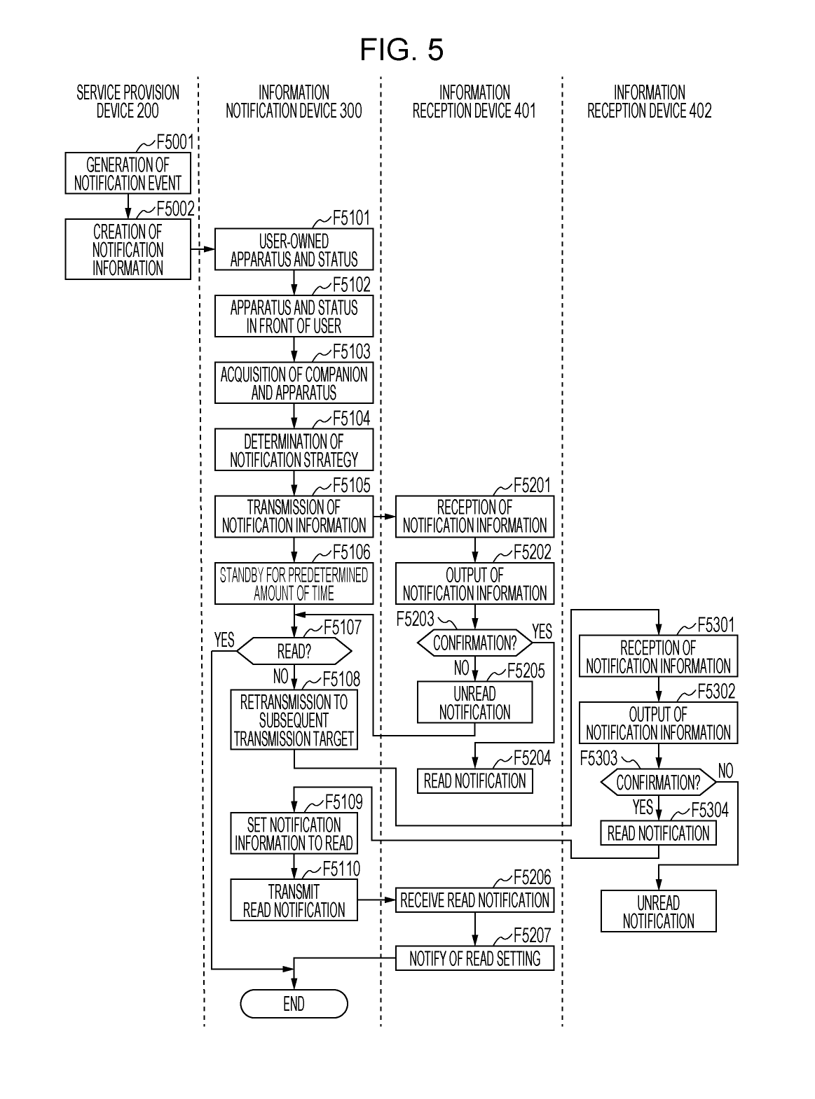

Next, a flow of processes that perform notification of notification information in the information notification system 100 according to a notification strategy will be described while referring to FIG. 5.

The service provision device 200 stands by for the occurrence of an event that will become an impetus for performing notification to a user (F5001). It is possible to include (a1) to (a5) below as events that is referred to in this instance, but the events that will become an impetus for performing notification to a user are not limited to these.

(a1) Approaching a schedule time of a user.
(a2) A user entering a specific area.
(a3) A message being delivered to a user.
(a4) Emergency warning information for which notification should be performed being generated in the manner of an earthquake, a typhoon, a fire or an accident.
(a5) Information of ticket sales of concerts, movies of the like being delivered.

Further, when an event occurs, the service provision device 200 creates notification information that is to be transmitted to a user (F5002), and transmits the notification information to the information notification device 300. The service provision device 200 creates notification information by determining a user that is to be a notification target of notification information, and an urgency, a secrecy and the like of the notification information depending on the content of the event that occurred. For example, the following items (b1) to (b6) are recorded in notification information. However, information that is listed in notification information is not limited to the information below, and in addition, not all of the following items (b1) to (b6) are necessary.

(b1) Information of the notification target user (such as identification information, an email address or the like of a user)

(b2) A subject

(b3) An urgency and an importance

(b4) A secrecy

(b5) A service identifier

(b6) Service-specific data (data that is individually defined for each service)

When notification information is received from the service provision device 200 on a side of the information notification device 300, the equipment management unit 306 assesses information that relates to pieces of equipment that a user that is a notification target owns and states thereof (F5101). The piece of equipment that the user owns is the information reception device 401 that the user is wearing on the body thereof, the information reception device 402 that the user is in possession of or the like. It is possible to include (c1) to (c5) below as examples of equipment information. However, equipment information is not limited to the following information, and in addition, not all of the following items (c1) to (c5) are necessary.

(c1) A model name or supported OS

(c2) Equipment capabilities or hardware configuration information (a resolution of display or network)

(c3) Notification means (of the data output unit 452) that the piece of equipment possesses (display, sound, vibration, LED or the like)

(c4) An equipment classification (wearable terminal, smartphone, tablet terminal, stationary, communal facility or the like)

(c5)

In addition, the equipment management unit 306 acquires the same information (c1) to (c5) as that above for pieces of equipment that are in front of a user (F5102). Pieces of equipment that are in front of the user include the information reception device 421 that is shared with users in the vicinity, the information reception device 422 that is installed in a communal place or the like, and is not limited to property of a notification target user. The equipment management unit 306 specifies a piece of equipment that is in front of the user on the basis of user attribute information of a notification target user that the action management unit 304 manages. It is possible to determine whether or not the piece of equipment is in front of a user on the basis of positional information, a face orientation and a line of sight direction of the user that is sent from the information reception device 401 of a notification target user as user attribute information.

The equipment management unit 306 may be configured to select or refuse candidates for transmission targets of notification information among information reception devices that are in front of a user on the basis of user attribute information such as positional information, a face orientation and a line of sight direction of a notification target user, and only acquire equipment information for selected information reception devices.

In addition, the equipment management unit 306 acquires the same equipment information (c1) to (c5) as that above for the information reception device 411 that a companion is carrying or wearing on the basis of information of a companion of user that is a notification target that the companion management unit 305 manages (F5103). The equipment management unit 306 may be configured to select or refuse candidates for transmission targets of notification information among a plurality of information reception devices that the companion is in possession of on the basis of user attribute information such as positional information, a face orientation and a line of sight direction of a notification target user, and only acquire equipment information for selected information reception devices.

Next, the function execution unit 301 of the information notification device 300 determines a notification strategy that will perform notification of notification information to a notification target user on the basis of the characteristics of notification information that is to be transmitted, the characteristics of each information reception device 401 . . . that is in the vicinity of a user that is a notification target and user attribute information (F5104).

The characteristics of notification information include an urgency and an importance, a secrecy and the like of the notification information. In addition, the characteristics of each information reception device 401 . . . include an owner of a piece of equipment (whether a notification target user themselves is wearing or in possession of the information reception device 401 . . . , whether the information reception device 401 . . . is the property of a companion, whether the information reception device 401 is the property shared between a plurality of users or whether the information reception device 401 . . . is a communal facility) and a state of the vicinity (whether people other than a user are present, or whether an installation location is a communal place), the equipment information (c1) to (c5) and the like.

Examples of the urgency and the secrecy of notification information are respectively shown in Table 1 and Table 2.

TABLE 1
Level of Importance and Content

| Level of Importance | Description |
|---|---|
| High | Notification information for which it |
| | will be unfavorable to a user if a |
| | notification is overlooked (taking |
| | medicine or a schedule change) |
| Low | Notification information for which |
| | there is no problem even if the |
| | notification information is ignored (a |
| | report in which a user has little |
| | interest) |

TABLE 2
Level of Secrecy and Content

| Level of Secrecy | Description |
|---|---|
| High | Notification information for which it |
| | is not desired that the existence of a |
| | notification be known to others |
| Normal | Notification information for which |
| | there is no problem even if the |
| | existence and content of a notification |
| | are known |

In the example that is shown in Table 1 above, two levels of importance of “high” for which it will be unfavorable to a user if notification information is overlooked and “low” for which there is no problem even if the notification information is ignored are defined. Naturally, a “medium” level for which a user's interest increases depending on a location or a time may be defined, or four or more levels of importance may be defined.

In Table 2 above, two levels of secrecy of “high” for which it is not desired that the existence of a notification be known to others and “normal” for which there is no problem even if the existence and content of a notification are known are shown as an example. Naturally, a “medium” level for which it is fine if the existence of a notification is known but there would be a problem if the content were known, or four or more levels of secrecy may be defined.

The notification strategy is a method that performs notification of notification information. The notification strategy includes a priority and a notification range of information reception devices that are to be transmission targets of notification information, the content of notification information for each transmission target, notification timing, a re-notification target in a case in which notification information that has been sent is unread, a number of times of re-notification and the like. Table 3 shows an example of a method that determines a notification strategy depending on a combination of the importance and the secrecy of notification information.

TABLE 3
Notification Strategy depending on Importance and Secrecy

| | Level of Importance: High | Level of Importance: Low |
|---|---|---|
| Level of | Firstly, display | Among pieces of equipment |
| Secrecy: | concurrently on pieces of | that a user owns, perform |
| High | equipment that a user is | notification on equipment |
| | carrying. Perform re- | other than a wearable |
| | notification after a | terminal and pieces of |
| | predetermined amount of | equipment that are used |
| | time has elapsed in a case | by a large number of |
| | in which the user does not | people. Do not perform |
| | confirm a notification. | re-notification. |
| Level of | Firstly, display | Among pieces of equipment |
| Secrecy: | concurrently on pieces of | that a user owns, perform |
| Low | equipment that a user is | notification on pieces of |
| | carrying. Perform re- | equipment other than a |
| | notification on a piece of | wearable terminal. Do not |
| | equipment that is in the | perform re-notification. |
| | vicinity of the user or a | |
| | piece of equipment that a | |
| | companion is carrying in a | |
| | case in which the user has | |
| | not confirmed the content. | |
| | Perform re-notification on | |
| | a piece of equipment that | |
| | is in the vicinity of a | |
| | movement target in a case | |
| | in which the user has | |
| | moved. | |

However, the technology that is disclosed in the embodiments of the present specification is not limited to the a specific notification strategy such as that shown in Table 3 above, and in addition, is not limited to a specific method that determines a notification strategy.

The function execution unit 301 may determine a notification strategy by further taking the characteristics of each information reception device 401 . . . that is in the vicinity of a user that is a notification target and user attribute information into consideration in addition to the characteristics of notification information that is to be sent such as the importance and the secrecy. In addition, the notification strategy may be converted into a rule.

Further, the function execution unit 301 transmits notification information to information reception devices that are in the vicinity of a notification target user (F5105) according to a priority that depends on a determined notification strategy. In the example that is shown in FIG. 5, the notification strategy is set as a notification strategy that determines a priority in an order of the information reception device 401, the information reception device 402, . . . .

When notification information is received on a side of the information reception device 401 (F5201), the function execution unit 451 presents the notification information to a user by outputting the notification information from the data output unit 452 (F5202).

The function execution unit 451 of the information reception device 401 controls a method that outputs notification information when notification information is output depending on equipment characteristics information of the information reception device 401. The equipment characteristics information that is referred to in this instance, is information such as a size and screen resolution of a display, whether the information reception device 401 is a piece of equipment that is used privately, whether the information reception device 401 is a piece of equipment that is shared by a large number of people and the like.

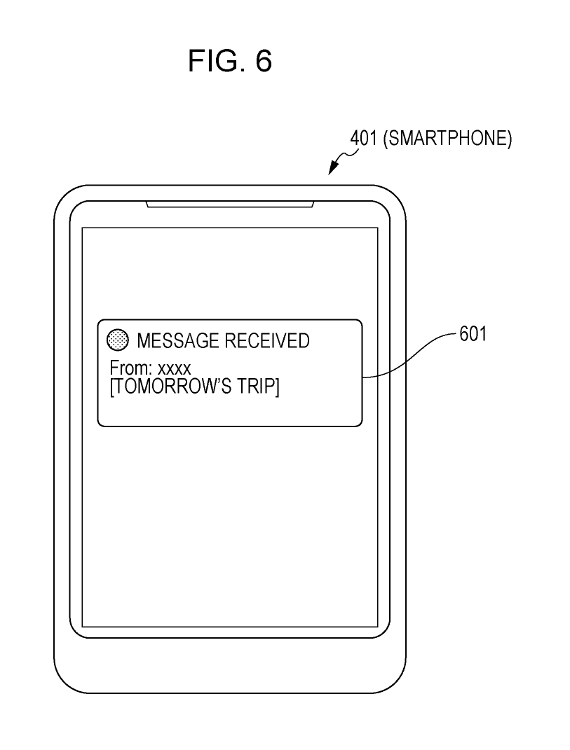

For example, in a case in which the information reception device 401 is a piece of equipment that a user possesses privately such as a smartphone, secrecy will not be lost even if all of the content of notification information with high secrecy is displayed. Therefore, as shown by reference numeral 601 in FIG. 6, a configuration in which actual notification information such as a sender of a message and a title are displayed, may be used.

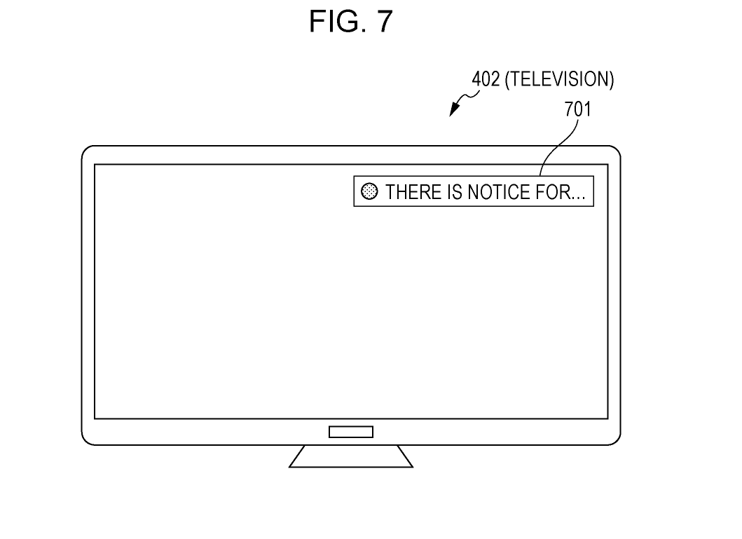

Meanwhile, in a case in which an information reception device that is a notification target being used by a large number of people in the manner of a television receiver that is installed in a home of a user, it may be fine if the fact that notification information has been delivered is known, but it is not desired that the contents of the notification information be known. In such an instance, as shown by reference numeral 701 in FIG. 7, a configuration in which only the existence of the fact that notification information has been delivered such as “There is a notice for . . . ” is displayed in place of displaying actual notification information, may be used.

In addition, in a case in which an information reception device that is a notification target being a piece of equipment in which the size and screen resolution of a display are small in the manner of a glasses-type terminal, since there is not enough space to display the entire content of the notification information, a configuration in which a portion of information only such as a title of notification information is displayed, may be used.

In addition, an information reception device 401 that has received notification information implements a read process of notification information. More specifically, when it is confirmed that a user has viewed notification information that has been presented by the data output unit 452 (F5203), in addition to setting received notification information to a read state, the function execution unit 451 of the information reception device 401 conveys the fact that the notification information has been read to the information notification device 300 using the data communication unit 459 (F5204). In F5203, for example, it is configured such that the reading of notification information is confirmed by the fact that a user manipulation that cancels notification information that is being output by the data output unit 452, has been performed.

Meanwhile, if it is not possible to confirm reading of notification information by a user, and certain conditions are satisfied, in addition to leaving the notification information in an unread state, the function execution unit 451 transmits an unread notification of notification information to the information notification device 300 (F5205). Alternatively, instead of transmitting an unread notification, the function execution unit 451 does not perform a read notification.

It is possible to include the fact that a user is not viewing notification information (including a case in which the user can view notification information, but has ignored the notification information for a predetermined period of time, or a case in which a user has not cancelled notification information within a predetermined period of time regardless of whether the user has viewed the notification information), a distance from a destination of a user coming within a certain range or the like as the certain conditions that are referred to in this instance. FIG. 5 explains a flow of processes that assume that an unread process of notification information is performed in the information reception device 401.

The information notification device 300 stands by for a predetermined period of time after notification information has been transmitted to the information reception device 401 in F5105 (F5106), and checks whether or not the notification information has been read on the information reception device 401 (F5107). When reading of the notification information has been confirmed, the information notification device 300 can finish processes with respect to this notification information. In the example that is shown in FIG. 5, since an unread notification is received from the information reception device 401, the information notification device 300 retransmits the notification information to the information reception device 402 that is a subsequent transmission target according to a notification strategy that was determined by F5104 (F5108).

Additionally, in a case in which a notification strategy that does not perform retransmission of notification information has been determined, even in a case in which there is not a read notification from the information reception device 401 that is a transmission target of notification information, retransmission of notification information is not performed.

In addition, in a case in which there is no read notification from the information reception device 401 that is a transmission target of notification information, retransmission is not performed according to a notification strategy that has already been determined, and a new notification strategy may be determined before F5108. This is because, for example, in a case in which a considerable amount of time has passed since a previous transmission of notification information to a user that is a notification target, and the user has moved from a previous location and exceeded a certain range, pieces of equipment that are in the vicinity of the user and companions have also changed, and therefore, the notification strategy is old.

In a case in which retransmission of notification information is performed, when notification information is received on a side of the information reception device 402 that is a transmission target of notification information (F5301), the function execution unit 451 presents the notification information to a user by outputting the notification information from the data output unit 452 (F5302). In addition, the function execution unit 451 of the information reception device 402 controls a method that outputs notification information when notification information is output depending on equipment characteristics information of the information reception device 402 (same as above).

In addition, an information reception device 402 that has received notification information implements a read process of notification information. When it is confirmed that a user has viewed notification information that has been presented by the data output unit 452 (F5303), in addition to setting received notification information to a read state, the function execution unit 451 of the information reception device 402 conveys the fact that the notification information has been read to the information notification device 300 using the data communication unit 459 (F5304). In F5303, for example, it is configured such that the reading of notification information is confirmed by the fact that a user manipulation that cancels notification information that is being output by the data output unit 452, has been performed.

The information notification device 300 stands by for a predetermined period of time after notification information has been retransmitted to the information reception device 402, and checks whether or not the notification information has been read on the information reception device 402 (F5107). Further, when reading of the notification information has been confirmed by the information reception device 402 that is a transmission target, the information notification device 300 is configured to set the notification information to read (F5109), and not perform retransmission of the same notification information thereafter.

In addition, the information notification device 300 transmits a read notification of notification information to the information reception device 401, the notification information of which is in an unread state (or in other words, a previous transmission target of notification information) (F5110).

When the information reception device 401 receives a read notification of notification information from the information notification device 300 (F5206), in addition to setting the notification information that was left in an unread state to a read state, the notification management unit 453 conveys the fact that the notification information has been set to read to the information notification device 300 (F5207).

Further, when the fact that the notification information has been set to a read state by the information reception devices 401 and 402 that are transmission targets of notification information, the information notification device 300 can finish processes with respect to this notification information.

Hereinafter, specific embodiments of the information notification system 100 will be described.

### Embodiment 1

In a first embodiment, it is assumed that a travel application that receives notification information at a travel destination and presents the notification information to a user is installed on reception devices 401 and 402 that the user is in possession of such as a glasses-type terminal and a smartphone. When the function execution unit 451 of each information reception device 401 and 402 executes the travel application, and detects the fact that the user has entered a region within a predetermined distance (for example, 500 meters) from a location (for example, a destination, a suggested store or the like), the notification information that has been transmitted from the information notification device 300 is presented to the user.

The notification information, which relates to a specific location at a travel destination or the like, is still of little interest to the user when the user is not close to that location, and it would be troublesome if notification is performed frequently, and therefore, there are instances in which the user would like to ignore the notification information. However, there are also instances in which it is beneficial if notification is performed ahead of time such that it is being possible to change a schedule so as to drop by the location.

In addition, if the user is not aware of the notification information when the user has approached within close range of the specific location, there is a concern that the specific location will be overlooked, and therefore, the user will pass by the location. Therefore, the importance and the urgency of the notification information are increased when a user has sufficiently approached the specific location.

In this manner, the notification information, which relates to the specific location, has a property of the importance and the urgency thereof changing depending on a distance from the user to the specific location. In such an instance, the information notification device 300 determines a notification strategy that corresponds to changes in the importance and the urgency that depend on a distance from the user to the specific location.

For example, the service provision device 200 or the information notification device 300 defines two kinds of notification information (d1) and (d2) which are shown below and depend on a distance from a user to a specific location for a certain specific location.

(d1) Notification Information 1: A notification that signifies that a user has entered a region within a predetermined range of a store (destination) that you have previously indicated you would like to go to.

(d2) Notification Information 2: A notification that signifies that a user has got closer to the destination than the stage of the notification information 1.

In addition, the service provision device 200 or the information notification device 300 creates two types of message (e1) and (e2) for each of the notification information 1 and the notification information 2.

(e1) Message 1: A message of “In 300 meters there is a . . . that you have previously indicated you would like to go to” in a case in which a user has entered a notification area.

(e2) Message 2: A message of “There is a . . . in this area” in a case in which a user has arrived in the general area of a destination.

The importance and the urgency of a notification in the notification information 1 when a distance from a specific location is comparatively far, are low, and the importance and the urgency of a notification in the notification information 2 when the specific location has been approached, are higher. Therefore, the information notification device 300 determines a number of times of re-notification and information reception devices that are to be transmission targets of the notification information 1 and the notification information 2 depending on the importance and the urgency. Since the notification information 1 and the notification information 2 are items of notification information that correspond to the same location, an identical notification ID is allocated thereto, but a number of times of re-notification of the notification information 1 for which the importance and the urgency are low, is set as 0, and a number of times of re-notification of the notification information 2 for which the importance and the urgency are high, is set as 1 (see below).

Notification Information 1

### Notification ID: 243

### Number of Times of Re-notification: 0

Notification Information 2

### Notification ID: 243

### Number of Times of Re-notification: 1

Further, when a notification target of the notification information 1, for which the importance and the urgency are low, is set as a smartphone, the information notification device 300 transmits the notification information 1 to the smartphone when a user has entered a region within a predetermined range from a . . . destination that the user has previously indicated the user would like to go to. When the smartphone receives the notification information 1, the smartphone shows that the notification information 1 has arrived by performing an incoming item tone, vibration, emission of an LED or the like. When a user is interested in the notification information, the user takes out a smartphone that was put away in a bag or a pocket, and can confirm a message of “In 300 meters there is a . . . that you have previously indicated you would like to go to” that signifies that a user has entered a notification area.

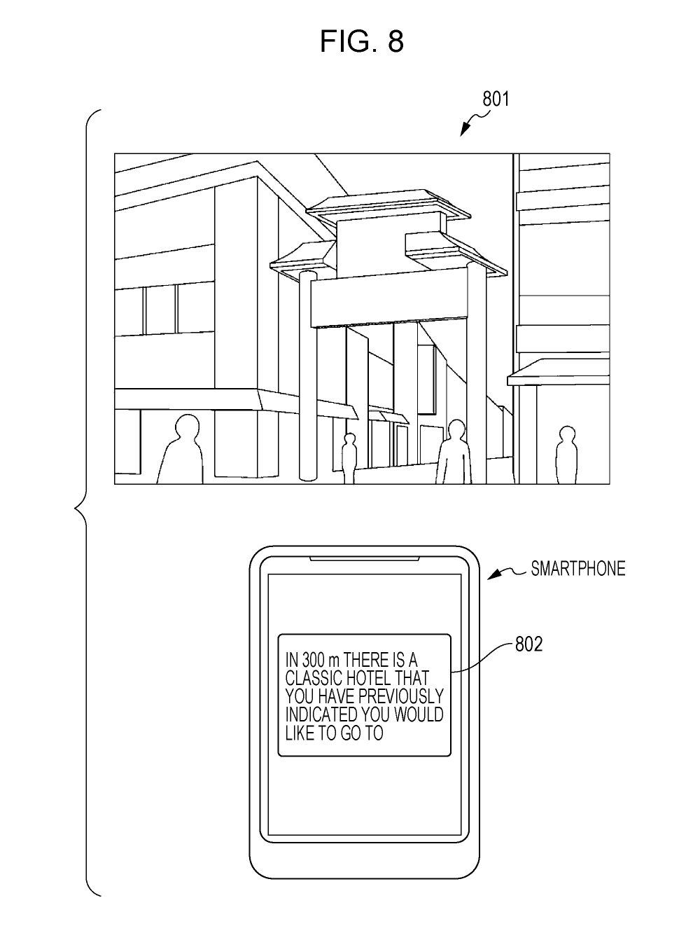

FIG. 8 shows a smartphone that displays a message 802 of “In 300 meters there is a classic hotel that you have previously indicated you would like to go to” when a user enters a certain range 801 of a destination. In addition, it is possible that the user will ignore the notification information even if the user is aware of the incoming item sound or the vibration when the user is not interested in the notification information, when the user is involved in a conversation with a friend, or when the user is not available due to being busy driving a car or the like.

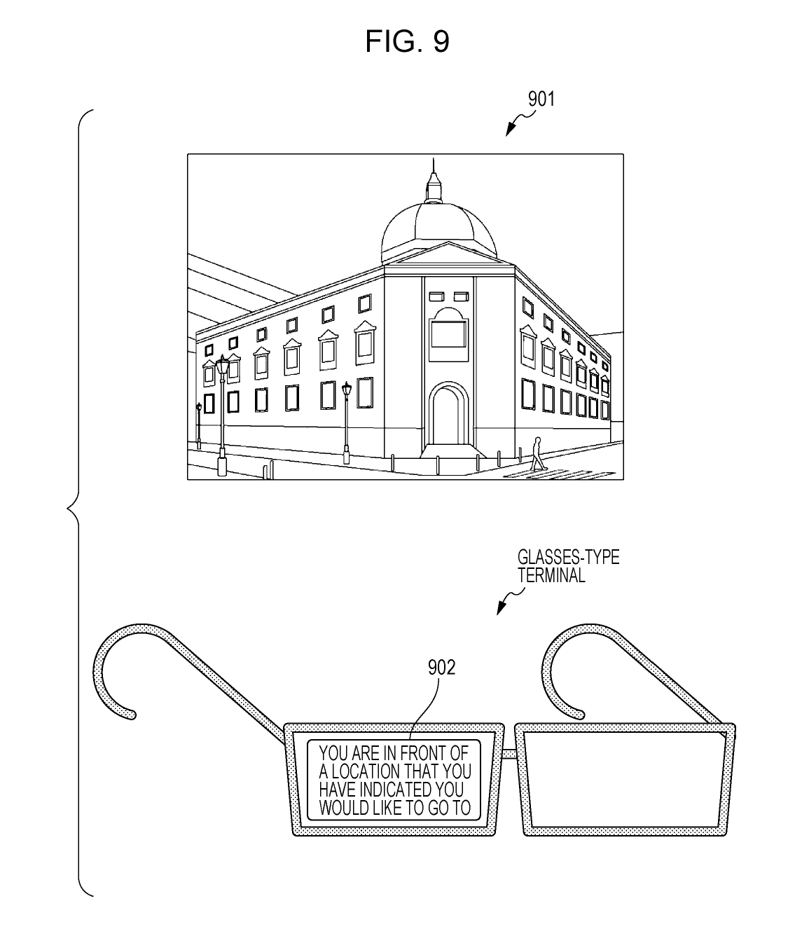

In addition, when a notification target of the notification information 2, for which the importance and the urgency are high, is set as a glasses-type terminal, the information notification device 300 transmits the notification information 2 to the glasses-type terminal when a user has got closer to a destination 901 than the stage of the notification information 1. The glasses-type terminal displays a message 902 of “You are in front of the location that you would like to go to” that signifies that a user has arrived in the general area of a destination on a display that is in front of the user. FIG. 9 shows a glasses-type terminal that displays a message when a user arrives in the general area of a destination. Since the message is displayed in front of the user, the user can confirm the notification information 2, the importance of which has increased, without overlooking the notification information 2.

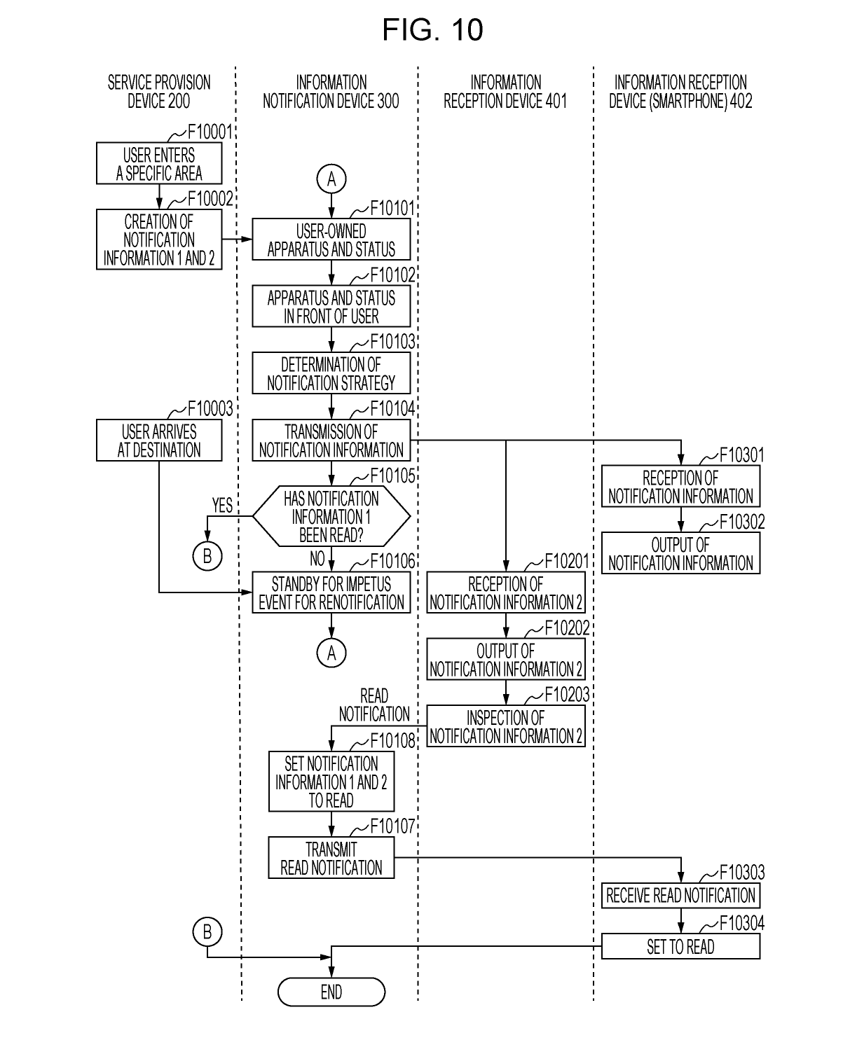

FIG. 10 shows a flow of processes that perform notification of notification information in the information notification system 100 according to a notification strategy that depends on a distance from a user to a specific location.

The service provision device 200 creates notification information 1 that signifies that a user has entered a notification area, and notification information 2 that signifies that a user has got closer to a destination than the stage of the notification information 1 (F10002) depending on a user entering a specific area from a destination (F10001), and transmits the notification information 1 and the notification information 2 to the information notification device 300. The specific area that is referred to in this instance may be the same as the notification area, or may be an area that is wider than the notification area.

When the two kinds of notification information 1 and 2, which relate to a destination of a user, are received from the service provision device 200 on a side of the information notification device 300, the equipment management unit 306 assesses information that relates to pieces of equipment that a user that is a notification target owns and states thereof (F10101). In the present embodiment, the information reception device 401 such as a glasses-type terminal that the user is wearing, and the information reception device 402 such as a smartphone that the user is in possession of due to insertion into a bag or the like are assumed as the pieces of equipment that the user owns.

In addition, in the same manner, the equipment management unit 306 acquires information that relates to pieces of equipment that are in front of a user and states thereof (F10102). The equipment management unit 306 specifies a piece of equipment that is in front of the user on the basis of user attribute information of a notification target user that the action management unit 304 manages.

In addition, although illustration has been omitted from the drawings, the equipment management unit 306 may also be configured to acquire information that relates to pieces of equipment and states thereof for the information reception device 411 that a companion is carrying or wearing on the basis of information of a companion of user that is a notification target that the companion management unit 305 manages.

Next, the function execution unit 301 determines a notification strategy that will perform notification of notification information to a notification target user on the basis of the characteristics of each item of notification information 1 and 2 and the characteristics of each information reception device 401 . . . that is in the vicinity of a user that is a notification target (F10103). In the present embodiment, a notification strategy such as that below is determined for each notification information 1 and 2.

(f1) Notification Information 1

### Importance or Urgency: Low

Transmission Target: Information Reception Device 402 (smartphone)
Transmission Timing: When user has entered a region within a predetermined range of destination
Number of times of re-notification: 0

(f2) Notification Information 2

### Importance or Urgency: High

### Transmission Target: Information Reception Device 401 (Glasses-type Terminal)

Transmission Timing: When user has got closer to the destination than the stage of the notification information 1.
Number of times of re-notification: 1

Further, the function execution unit 301 transmits the notification information according to a determined notification strategy (F10104).

Firstly, the function execution unit 301 transmits the notification information 1, for which the importance and the urgency are low, to the information reception device 402 such as a smartphone when a user has entered a region within a predetermined range of a destination. When the notification information 1 is received on the smartphone (F10301), in addition to displaying the notification information 1 on a screen, the smartphone shows that the notification information 1 has arrived by performing an incoming item tone, vibration, emission of an LED or the like (F10302).

When a user is interested in the notification information 1, the user takes out a smartphone that was put away in a bag or a pocket, and can confirm a message 802 (refer to FIG. 8) of “In 300 meters there is a that you have previously indicated you would like to go to” that signifies that a user has entered a notification area. However, in the example that is shown in FIG. 10, the user is not interested in, and therefore, ignores the notification information 1 or is not aware of the incoming item tone or the vibration. In this case, the information reception device 402 performs notification of unread notification information 1 to the information notification device 300 or does not perform a read notification.

On a side of the information notification device 300, it is checked whether or not a read notification of the notification information 1 has been received from the information reception device 402 (F10105). When receipt of a read notification of the notification information 1 has been confirmed (Yes in F10105), the information notification device 300 can finish processes of the notification information that relates to a corresponding destination to the user.

Meanwhile, if the information reception device 402 is in an unread state with respect to the notification information 1 (No in F10105), stands by for an event that will become an impetus for performing re-notification of the notification information that relates to the corresponding destination (F10106). An event that will become an impetus for performing re-notification of the notification information is more specifically, the user getting closer to a destination than the stage of the notification information (F10003), and in this case, the information notification device 300 returns to the F10101, and executes a repetition of the same processes as above.

The function execution unit 301 transmits the notification information 2, for which the importance and the urgency are high, to the information reception device 401 such as a glasses-type terminal (F10103) depending on an event that will become an impetus for performing re-notification such as the user getting closer to a destination than the stage of the notification information 1 (F10003).

When the notification information 2 is received (F10201), the information reception device 401 displays a message 902 (refer to FIG. 9) of “There is a in this area” that signifies that a user has arrived in the general area of a destination on a display that is in front of the user (F10202). In a case in which the information reception device 401 is a glasses-type terminal, since the message is displayed in front of the user, the user can confirm the notification information 2, the importance of which has increased, without overlooking the notification information (F10203).

In addition, the information reception device 401 implements a read process of notification information. In addition to setting received notification information to a read state, the function execution unit 451 of the information reception device 401 conveys the fact that the notification information has been read to the information notification device 300 using the data communication unit 459. In a case in which the notification information 2 is displayed on a glasses-type terminal, since it is certain that the user has inspected the notification information 2, it may be configured so that a notification of reading is performed without manipulation that cancels the notification information being necessary.

When a read notification of the notification information 2 of received from the information reception device 401, the information notification device 300 is configured to set both the notification information 1 and the notification information 2 that relate to the corresponding destination to read (F10107), and not perform transmission of the notification information 1 and the notification information 2 that relate to the same destination thereafter.

In addition, the information notification device 300 transmits a read notification of the notification information 1 to the information reception device 402 (F10108), the notification information 1 of which is in an unread state (or in other words, a transmission target of the notification information 1). When a read notification is received on a side of the information reception device 402 (F10303), in addition to setting the notification information 1 that was left in an unread state to a read state (F10304), the notification management unit 453 conveys the fact that the notification information 1 has been set to a read state to the information notification device 300.

Further, when the fact that the notification information 1 and the notification information 2 have been set to a read state by the information reception devices 401 and 402 that are transmission targets of notification information, the information notification device 300 finishes processes with respect to this notification information.

According to the first embodiment, it is possible for a user to learn of important notification information without being aware of the importance of the notification information. In addition, it is possible for a user to learn of important notification information without being aware of the fact that the importance and the urgency thereof have increased depending on distance to a destination or the like.

### Embodiment 2

In a second embodiment, notification information is presented to a user using an information reception device 402 that the user that has returned home is in possession of, and an information reception device 421 that is in the vicinity of the user. More specifically, scenarios (g1) to (g5) such as those below are assumed.

(g1) The user has returned home.

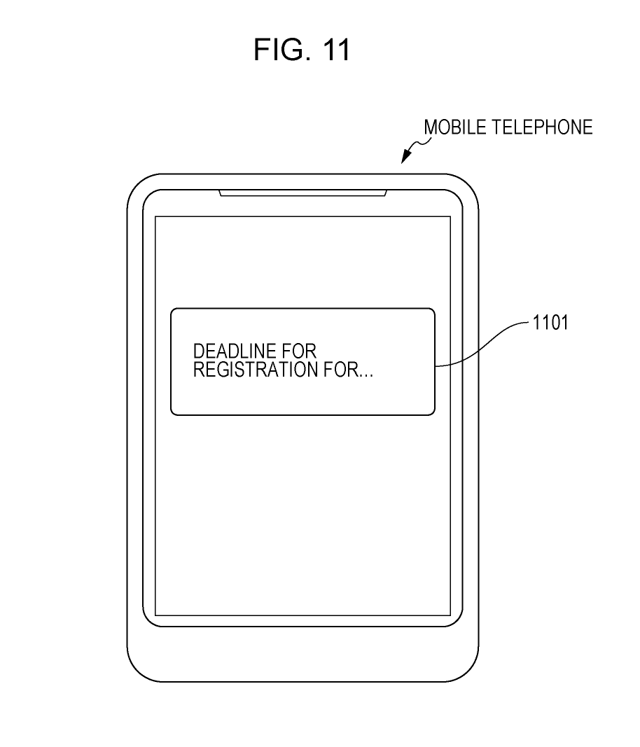

(g2) The user has moved to a living room leaving a mobile telephone in a bedroom. Notification information is delivered to the mobile telephone, and notification information that is formed from a message 1101 such as “Deadline for registration for . . . ” is displayed (refer to FIG. 11). Since the mobile telephone is left in the bedroom and is not at hand, it is not possible for the user to confirm the contents of the notification information, and therefore, the notification information is in an unread state.

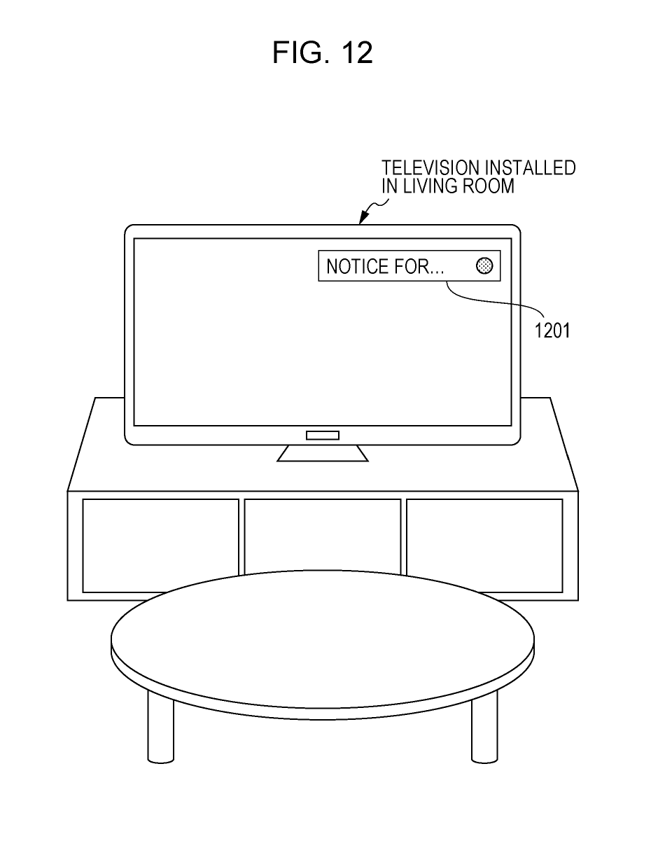

(g3) The user is watching a television in the living room. Since it is not possible to confirm reading of the notification information that was transmitted to the mobile telephone, the television that is installed in the living room which the user is in is set as a re-notification target, the notification information is retransmitted to the television. Since the television is a piece of equipment that is used by a large number of people, a message 1201 such as “new notice” that only shows that there is notification information that relates to the user, is displayed rather than displaying the content of the notification information as it is (refer to FIG. 12).

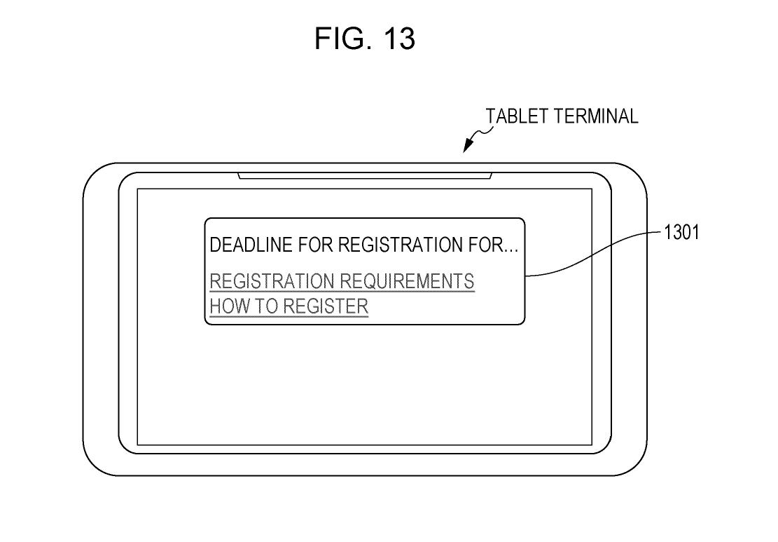

(g4) The user picks up and activates a shared tablet terminal that is resting on a living room table. A re-notification target of the unread notification information is set when the user that is a notification target of the notification information is recognized through facial recognition of a captured image of a camera that is attached to the tablet terminal. A summary 1301 of the notification information is displayed on the tablet terminal (refer to FIG. 13), and it is possible for the user to confirm the content of the notification information.

(g5) The notification information attains a read state when detailed content of the notification information has been confirmed on the tablet terminal. In addition to the notification information disappearing from the tablet terminal, the display on the television and the mobile telephone also disappear.

The information notification device 300 can realize a process of notification information along the lines of the abovementioned scenarios (g1) to (g5) according to the process flow that is shown in FIG. 5.

When an event that will become an impetus for performing notification to a user occurs (F5001), the service provision device 200 creates notification information that is to be transmitted to a user (F5002), and transmits the notification information to the information notification device 300.

The information notification device 300 assesses pieces of equipment that the user owns as pieces of equipment that are in the vicinity of the user that is a notification target (F5101). In addition, the information notification device 300 assesses a living room television that is in front of the user and a shared tablet terminal that is resting on a living room table on the basis of a state in which the user has returned home and has moved to the living room (F5102). Further, the information notification device 300 determines a notification strategy that will perform notification of notification information to a notification target user on the basis of the characteristics of notification information that is to be transmitted, the characteristics of each information reception device 401 . . . that is in the vicinity of a user that is a notification target and user attribute information (F5104).

Firstly, the information notification device 300 transmits notification information to the mobile telephone, for which the priority is the highest (F5105). The notification information is delivered to the mobile telephone (F5201), and the notification information is displayed on the mobile telephone (F5202). However, the user has moved to the living room leaving the mobile telephone in the bedroom. Therefore, since it is not possible for the user to confirm the content of the notification information, the notification information is in an unread state. The mobile telephone transmits an unread notification of notification information to the information notification device 300 (F5205). Alternatively, instead of transmitting an unread notification, the mobile telephone does not perform a read notification.

Since it was not possible to confirm reading of the notification information from the mobile telephone that is a transmission target (F5107), the information notification device 300 retransmits the notification information to a subsequent notification target (F5108). In the present embodiment, since the user has moved to the living room and is viewing the television, in the notification strategy, the television that is installed in the living room, and a shared tablet terminal that is resting on a living room table are set as subsequent transmission targets.

When the notification information is received from the information notification device 300 (F5301), the television displays the fact that there is notification information that relates to the user (F5302). However, if notification information is displayed on the television that is installed in the living room, the content thereof will be well-known amongst a family. Between family members, it may be fine if the fact that the notification information has been delivered is known, but it may not desired that the contents of the notification information be known. In such an instance, only the existence of the fact that the notification information has been delivered is displayed on the television in place of displaying actual notification information (refer to FIG. 12).

In addition, when the notification information is received from the information notification device 300 (F5301), the tablet terminal that is resting on the living room table also displays a summary of the notification information (F5302). In the same manner as the television, the tablet terminal is shared between a family that is in the living room, but when the user picks up the tablet terminal, the display content is obscured from the surrounding area. Therefore, the user can confirm the content of the notification information from a summary of the notification information that is displayed on the tablet terminal (refer to FIG. 13).

The tablet terminal implements a read process of notification information when it is confirmed that a user has viewed the notification information (for example, the user access the content of each item of notification information that is displayed as a summary by tapping) (F5303). In addition to deleting the notification information from the screen thereof, the tablet terminal conveys the fact that the notification information has been read to the information notification device 300 (F5304).

When reading of the notification information has been confirmed by the tablet terminal that is a re-notification target, the information notification device 300 is configured to set the notification information to a read state (F5109), and not perform retransmission of the same notification information thereafter. In addition, the information notification device 300 transmits a read notification of the notification information to the mobile telephone and the television, the notification information of which are in an unread state (or in other words, previous transmission targets of notification information) (F5110). As a result of this configuration, the displays on the mobile telephone and the television that relate to the notification information also disappear.

The secrecy of the information reception devices such as the mobile telephone, the television and the tablet terminal is diverse depending on characteristics and statuses of the equipment such as whether the information reception devices are possessed by a specific user, whether the information reception devices are shared between a plurality of users, where the information reception devices are installed, and whether the specific user has picks up and uses the information reception device.

In a case of a piece of equipment that the user possesses privately, secrecy will not be lost even if all of the content of notification information with high secrecy is displayed, and therefore, the secrecy of the notification information is not lost by displaying the notification information. Meanwhile, in a case of a piece of equipment that is shared by a plurality of users or a piece of equipment being seen by other users, it may be fine if the fact that notification information has been delivered is known, but it is not desired that the contents of the notification information be known. In such an instance, each information reception device 401 may be configured to control a display method of received notification information depending on the secrecy thereof.

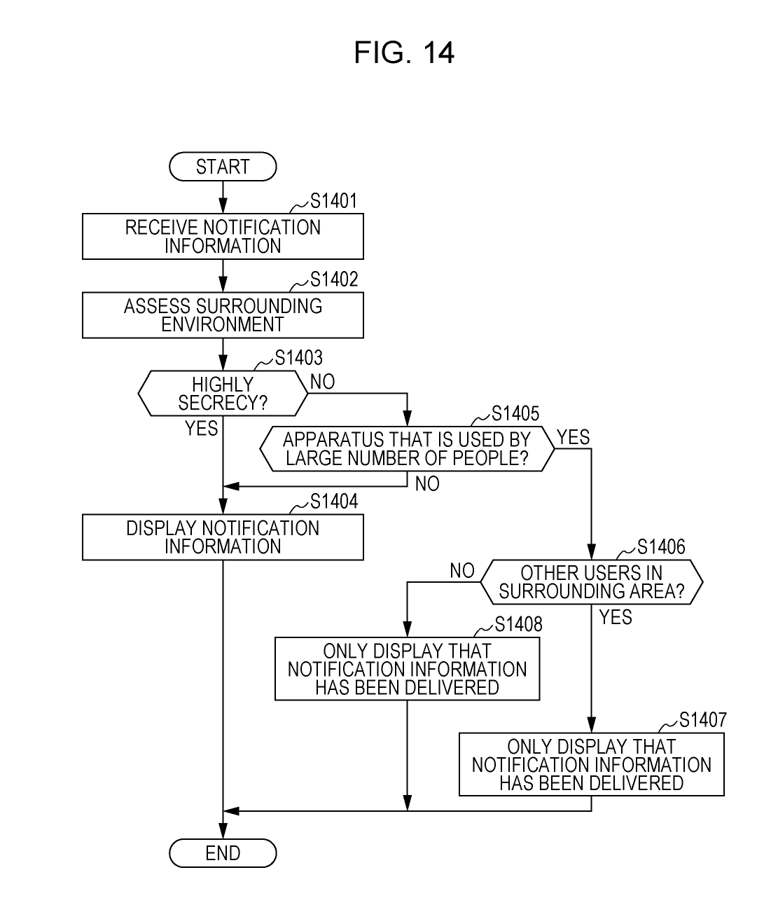

FIG. 14 shows a process sequence for controlling a display method of received notification information in each information reception device 401 . . . in flowchart form.

When notification information is received from the information notification device 300 (Step S1401), firstly, the information reception device assesses a surrounding environment that the information reception device is placed in (Step F1402) on the basis of a detection result in the sensor unit 457, and checks whether or not the information reception device is left in a state in which the secrecy is high (Step F1403). A surrounding environment, for example, is whether or not people other than the user are in the surrounding area of the information reception device, and it is possible to assess on the basis of a recognition result of the user recognition unit 455.

In this instance, in a case in which the secrecy is high (Yes in Step S1403), the information reception device displays the content of the received notification information (Step S1404), and finishes the present process routine.

Meanwhile, in a case in which the secrecy is low (No in Step S1403), the information checks whether or not the information reception device is a piece of equipment that is used by a large number of people (Step S1405).

In a case in which the information reception device is piece of equipment that is not used by a large number of people (No in Step S1405), since the piece of equipment is placed in a state with high secrecy, the information reception device displays the content of the received notification information (Step S1404), and finishes the present process routine.

In addition, in a case in which the information reception device is piece of equipment that is used by a large number of people (Yes in Step S1405), the information reception device checks whether or not users other than the user that is a notification target of the notification information are in the surrounding area on the basis of a determination result in the sensor unit 457 or the like (Step S1406).

When there are other users are in the surrounding area of the information reception device or it is not possible to confirm that other users are not in the surrounding area (Yes in Step S1406), the information reception device only displays a mark (Step S1407), and finishes the present process routine.

In addition, other users are not in the surrounding area of the information reception device (No in Step S1406), the information reception device only displays the fact that notification information has been delivered instead of displaying the notification information itself (Step S1408), and finishes the present process routine.

According to the Second Embodiment, in the information notification system 100, a notification method of notification information is controlled depending on the secrecy of the notification information. Therefore, a user that is a notification target can receive notification information without information with high secrecy being leaked to other people. In addition, even if a user is not carrying equipment that the user themselves own such as a mobile telephone, it is possible for a user to receive notification information from a television that is installed in a living room, a tablet terminal that is shared with other users or the like.

### Embodiment 3

In a third embodiment, a user A has a chronic disease, and notification of notification information that shows that it is approaching a time to take medicine is performed. More specifically, scenarios (h1) to (h4) such as those below are assumed.

(h1) The user A that is a notification target of notification information is on holiday with a friend user B, and the users are travelling together. The user A is in possession of a mobile telephone, and the user B is wearing a glasses-type terminal.

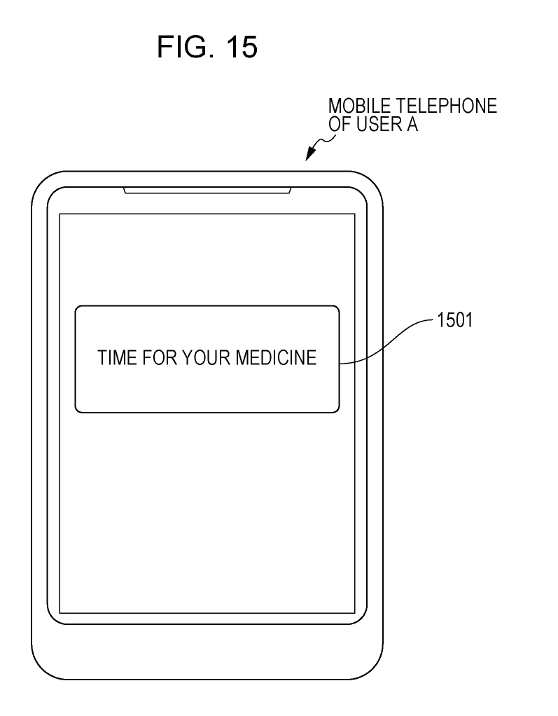

(h2) Notification information that shows that it is approaching a time for the user A to take medicine is transmitted to the mobile telephone of the user A from the information notification device 300. Notification information 1501 that is formed from a message such as “Time for your medicine” is displayed on the mobile telephone (refer to FIG. 15).

(h3) The user A is deep in conversation with the user B, and ignores the notification information that is displayed on the mobile telephone as the user A is not aware of it.

(h4) The information notification device 300 determines the user B as a companion on the basis of positional information and social graph information of each of the users A and B, sets the glasses-type terminal that the user B is wearing as a re-notification target of the notification information that is intended for the user A, and transmits the notification information.

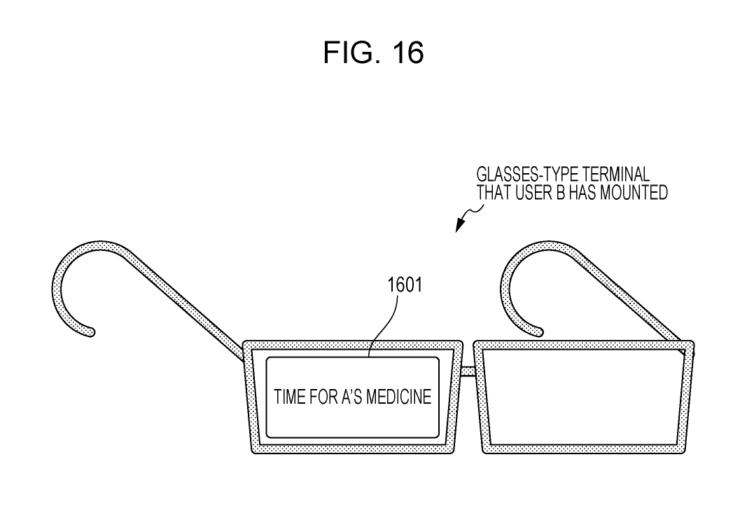

(h5) When notification information that shows that it is approaching a time for the user A that the user B is accompanying to take medicine is received, the glasses-type terminal displays a message 1601 such as “Time for . . . 's medicine” (refer to FIG. 16). Since the notification information is displayed in front of the user themselves, the user B does not overlook the notification information. As a result of the user B telling the user A that it is time to take medicine, it is possible for the user A to avoid forgetting to take medicine.

The information notification device 300 can realize a process of notification information along the lines of the abovementioned scenarios (h1) to (h5) according to the process flow that is shown in FIG. 5.

When it gets within a predetermined amount of time until a time for the user A to take medicine (F5001), the service provision device 200 creates notification information that is to notify the user A that it is time to take medicine (F5002), and transmits the notification information to the information notification device 300.

The information notification device 300 assesses the mobile telephone that the user A owns as a piece of equipment that is in the vicinity of the user that is a notification target (F5101). Further, in addition to specifying that the user B is a companion of the user A, the information notification device 300 assesses the glasses-type terminal that the user B is wearing on the basis of positional information of each user A and b and social graph information (F5103).

Further, the information notification device 300 determines a notification strategy that will perform notification of the notification information that is intended for the user A on the basis of the characteristics of the notification information that is to be transmitted to the user A, the characteristics of the companion, and the characteristics of each information reception device.

Firstly, the information notification device 300 transmits notification information to the mobile telephone that the user A is in possession of, for which the priority is the highest (F5105). The notification information is delivered to the mobile telephone of user A (F5201), and the notification information is displayed on the mobile telephone (F5202). However, the user A is deep in conversation with the friend user B, and ignores the notification information that is displayed on the mobile telephone as the user A is not aware of it. Therefore, the notification information is in an unread state. The mobile telephone transmits an unread notification of notification information to the information notification device 300 (F5205). Alternatively, instead of transmitting an unread notification, the mobile telephone does not perform a read notification.

Since it was not possible to confirm reading of the notification information from the mobile telephone that is a transmission target (F5107), the information notification device 300 retransmits the notification information to a subsequent notification target (F5108). In the present embodiment, the glasses-type terminal that the user B is wearing is set as a re-notification target of notification information that is intended for the user A, and the information notification device 300 transmits the notification information.

When the notification informationed that shows that it is approaching a time for the user A that the user B is accompanying to take medicine (F5301), the glasses-type terminal of the user B displays this (F5302). It is supposed on the basis of social graph information of each user A and B that the user B is friendly with the user A, and that it will not be a problem for the user A if the user B knows the content of the notification information. Since the notification information is displayed in front of the user themselves, the user B does not overlook the notification information. As a result of the user B telling the user A that it is time to take medicine, it is possible for the user A to avoid forgetting to take medicine.

5303

In addition, the glasses-type terminal of the user B confirms that the user B has not overlooked the notification information through the notification information being displayed to the user A, and considers that the content of the notification information has been conveyed to the user A (F5303), and implements a read process of notification information. In addition to deleting the notification information from the screen thereof, the glasses-type terminal conveys the fact that the notification information has been read to the information notification device 300 (F5304).

When reading of the notification information has been confirmed by the glasses-type terminal of the user B that is a re-notification target, the information notification device 300 is configured to set the notification information to a read state (F5109), and not perform retransmission of the same notification information thereafter. In addition, the information notification device 300 transmits a read notification of the notification information to the mobile telephone of the user A, the notification information of which is in an unread state (or in other words, a previous transmission target of the notification information) (F5110). As a result of this configuration, the display on the mobile telephone also disappears.

According to the Third Embodiment, by transmitting notification information to piece of equipment that a companion of a user that is a notification target is in possession of, it is even possible to convey the notification information through the companion in a case in which the notification information that is displayed on a piece of equipment that the user owns has been ignored. In addition, since the attention of a user is alerted to the notification information by a companion, it is possible to improve the compulsion for performing an action that relates to the notification information in comparison with a case in which notification information is repeatedly transmitted to a piece of equipment that a user themselves own.

Additionally, it is possible for the technology that is disclosed in the embodiments of the present specification to have the following configurations.

(1) An information notification device that includes an equipment management unit that manages a plurality of pieces of equipment which are in a vicinity of a user, and a function execution unit that executes transmission of notification information to any one of the plurality of pieces of equipment by determining a notification strategy that will perform notification of notification information to a user.
(2) The information notification device according to (1), in which the function execution unit determines a notification strategy that relates to a notification target piece of equipment of notification information or a notification method of notification information to a piece of equipment on the basis of at least one of characteristics of notification information or respective characteristics of the plurality of pieces of equipment.
(3) The information notification device according to (1), in which the function execution unit determines a notification strategy that is formed from at least one of a priority of pieces of equipment that are to be transmission targets of notification information, a notification range of notification information, a re-notification target in a case in which notification information is unread, and a number of times of re-notification.
(4) The information notification device according to (1), in which the information notification device further includes an action management unit that manages positional information of a user or actions of a user, and the function execution unit sets a transmission target of notification information depending on positional information of a user or actions of a user.
(5) The information notification device according to (1), in which the information notification device further includes a companion management unit that manages information of a companion that is acting with a user, the equipment management unit further manages a piece of equipment that a companion is carrying or wearing, and the function execution unit determines a notification target or a re-notification target of notification information from two or more pieces of equipment that include a piece of equipment that a user is carrying or wearing, and a piece of equipment that a companion is carrying or wearing according to a notification strategy.
(6) The information notification device according to (5), in which the companion management unit determines a companion of a user on the basis of positional information of a piece of equipment that a user is in possession of, personal information of a user or social graph information between users.
(7) The information notification device according to (5), in which the function execution unit sets a piece of equipment that a companion is in possession of as a re-notification target of notification information in a case in which notification information that was transmitted to a piece of equipment that a user is in possession of is unread.
(8) The information notification device according to (5), in which the function execution unit performs notification or re-notification of notification information to a piece of equipment that a companion is in possession of within a range or a notification method that an importance, an urgency, a secrecy or another characteristic of the notification information allows.
(9) The information notification device according to (1), in which the equipment management unit further manages a piece of equipment that is used by a large number of people, a piece of equipment that is shared with users in the vicinity, or a piece of equipment that is installed in a communal location, and the function execution unit determines a notification target or a re-notification target of notification information from two or more pieces of equipment that include a piece of equipment that a user is carrying or wearing, a piece of equipment that is used by a large number of people, a piece of equipment that is shared with users in the vicinity, or a piece of equipment that is installed in a communal location.
(10) The information notification device according to (9), in which the function execution unit sets any one of a piece of equipment that is used by a large number of people, a piece of equipment that is shared with users in the vicinity, or a piece of equipment that is installed in a communal location as a re-notification target of notification information in a case in which notification information that was transmitted to a piece of equipment that is in the possession of a user is unread.
(11) The information notification device according to (9), in which function execution unit performs notification or re-notification of notification information to any one of a piece of equipment that is used by a large number of people, a piece of equipment that is shared with users in the vicinity, or a piece of equipment that is installed in a communal location using a range or a notification method that an urgency, an importance or another characteristic of the notification information allows.
(12) The information notification device according to (1), in which the information notification device further includes a notification management unit that manages a notification state of notification information to a piece of equipment, and the function execution unit performs re-notification of notification information or a notification information process on the basis of a notification state that the notification management unit manages and a notification strategy.
(13) The information notification device according to (12), in which the function execution unit also performs re-notification of notification information that is in an unread state on the basis of a notification strategy on any piece of equipment to which notification or re-notification has been performed.
(14) The information notification device according to (12), in which the function execution unit deletes notification information that has attained an already read state from any piece of equipment to which notification or re-notification has been performed.
(15) The information notification device according to (12), in which, when notification information has attained a read state on any piece of equipment to which notification or re-notification has been performed, the function execution unit also sets an unread state on other pieces of equipment that have an unread state.
(16) The information notification device according to (1), in which the function execution unit transmits first notification information when a user comes within a certain range of a destination, and transmits second notification information when a user gets closer to a destination.
(16-1) The information notification device according to (16), in which the first notification information includes information for which the urgency and the importance are low, and the second notification information includes information for which the urgency and the importance are high.
(16-2) The information notification device according to (16), in which a piece of equipment that a user that is a notification target is in possession of is set as a transmission target of the first notification information, and a piece of equipment that the user that is a notification target is wearing on the body thereof is set as a transmission target of the second notification information.
(16-3) The information notification device according to (16), in which the number of times of re-notification of the second notification information is greater than that of the first notification information.
(17) The information notification device according to (1), in which the function execution unit sets a piece of equipment that is used by a large number of people that is in the vicinity of a user, or a piece of equipment that is shared with users in the vicinity as a re-notification target of notification information in a case in which notification information that has been transmitted to a piece of equipment that a user owns is unread.
(18) The information notification device according to (1), in which function execution unit sets a piece of equipment that a companion owns as a re-notification target of notification information in a case in which notification information that has been transmitted to a piece of equipment that a user owns is unread.
(19) An information notification method that includes managing a plurality of pieces of equipment which are in a vicinity of a user, and executing transmission of notification information to any one of the plurality of pieces of equipment by determining a notification strategy that will perform notification of notification information to a user.
(20) An information reception device that includes a data output unit, and a function execution unit that outputs notification information that is received from an information notification device from the data output unit using a notification method that depends on characteristics of notification information or characteristics of the corresponding information reception device itself.
(21) The information reception device according to (20), in which notification information with either a user that owns a corresponding information reception device, a companion, or a user that is in the vicinity of the corresponding information reception device as the notification target thereof is received from the information notification device, and output from the data output unit.
(22) The information reception device according to (20), in which the information reception device further includes an action recognition unit that recognizes an action state of a user that owns the corresponding information reception device, and the function execution unit outputs notification information from the data output unit using a notification method that corresponds to a recognition result of the action recognition unit.
(22-1) The information reception device according to (22), in which notification of a recognition result of the action recognition unit is performed to the information notification device.
(23) The information reception device according to (20), in which the information reception device further includes a user recognition unit that recognizes a user that owns the corresponding information reception device or a user that is in a vicinity of the corresponding information reception device, and the function execution unit outputs notification information from the data output unit using a notification method that depends on a recognition result of the user recognition unit.
(23-1) The information reception device according to (23), in which the function execution unit outputs notification information from the data output unit using a notification method corresponds to a secrecy of the notification information and a surrounding environment that the user recognition unit recognizes.
(23-2) The information reception device according to (23), in which notification of a recognition result of the user recognition unit is performed to the information notification device.
(24) The information reception device according to (20), in which the data output unit is provided with a display, an acoustic device, a vibrator or a combination of two or more of these.
(25) The information reception device according to (20), in which the function execution unit activates software that corresponds to notification information received from the information notification device.
(26) The information reception device according to (20), in which notification information that a user has confirmed is set to a read state.
(27) The information reception device according to (26), in which notification of the fact that the notification information has been read is performed to the information notification device that is a transmission source of notification information.
(28) The information reception device according to (26), in which the output of notification information that has been read is deleted from the data output unit.
(29) The information reception device according to (26), in which notification information that is in an unread state changes to a read state depending on a notification from the information notification device.
(30) An information reception method that includes receiving notification information from an information notification device, and outputting notification information from the information reception device using a notification method that depends on characteristics of notification information or characteristics of the information reception device.
(31) A computer program that is written in a computer-readable format so as to cause a computer to function as an equipment management unit that manages a plurality of pieces of equipment which are in a vicinity of a user, and a function execution unit that executes transmission of notification information to any one of the plurality of pieces of equipment by determining a notification strategy that will perform notification of notification information to a user.
(32) A computer program that is written in a computer-readable format so as to cause a computer to function as a data output unit, and a function execution unit that outputs notification information that is received from an information notification device from the data output unit using a notification method that depends on characteristics of notification information or characteristics of a corresponding information reception device.
(33) An information notification system that is provided with a plurality of information reception devices that are in the vicinity of a user, a service provision device that provides notification information to a user, and an information notification device that transmits notification information to any one of the information reception devices that are in the vicinity of a user that is a notification target.

It should be understood by those skilled in the art that various modifications, combinations, sub-combinations and alterations may occur depending on design requirements and other factors insofar as they are within the scope of the appended claims or the equivalents thereof.

What is claimed is:

1. An information notification device comprising:
an equipment management unit that manages a plurality of pieces of equipment which are in a vicinity of a user; and
a function execution unit that executes transmission of notification information to any one of the plurality of pieces of equipment by determining a notification strategy that will perform notification of notification information to a user.

2. The information notification device according to claim 1,
wherein the function execution unit determines a notification strategy that relates to a notification target piece of equipment of notification information or a notification method of notification information to a piece of equipment on the basis of at least one of characteristics of notification information or respective characteristics of the plurality of pieces of equipment.

3. The information notification device according to claim 1,
wherein the function execution unit determines a notification strategy that is formed from at least one of a priority of items of equipment that are to be transmission targets of notification information, a notification range of notification information, a re-notification target in a case in which notification information is unread, and a number of times of re-notification.

4. The information notification device according to claim 1, further comprising:
an action management unit that manages positional information of a user or actions of a user,
wherein the function execution unit sets a transmission target of notification information depending on positional information of a user or actions of a user.

5. The information notification device according to claim 1, further comprising:
a companion management unit that manages information of a companion that is acting with a user,
wherein the equipment management unit further manages a piece of equipment that a companion is carrying or wearing, and
wherein the function execution unit determines a notification target or a re-notification target of notification information from two or more pieces of equipment that include a piece of equipment that a user is carrying or wearing, and a piece of equipment that a companion is carrying or wearing according to a notification strategy.

6. The information notification device according to claim 1,
wherein the equipment management unit further manages a piece of equipment that is used by a large number of people, a piece of equipment that is shared with users in the vicinity, or a piece of equipment that is installed in a communal location, and
wherein the function execution unit determines a notification target or a re-notification target of notification information from two or more pieces of equipment that include a piece of equipment that a user is carrying or wearing, a piece of equipment that is used by a large number of people, a piece of equipment that is shared with users in the vicinity, or a piece of equipment that is installed in a communal location.

7. The information notification device according to claim 6,
wherein the function execution unit sets any one of a piece of equipment that is used by a large number of people, a piece of equipment that is shared with users in the vicinity, or a piece of equipment that is installed in a communal location as a re-notification target of notification information in a case in which notification information that was transmitted to a piece of equipment that is in the possession of a user is unread.

8. The information notification device according to claim 6,
wherein the function execution unit performs notification or re-notification of notification information to any one of a piece of equipment that is used by a large number of people, a piece of equipment that is shared with users in the vicinity, or a piece of equipment that is installed in a communal location within a range or a notification method that an urgency, an importance or another characteristic of the notification information allows.

9. The information notification device according to claim 1, further comprising:
a notification management unit that manages a notification state of notification information to a piece of equipment,
wherein the function execution unit performs re-notification of notification information or a notification information process on the basis of a notification state that the notification management unit manages and a notification strategy.

10. The information notification device according to claim 9,
wherein the function execution unit also performs re-notification of notification information that is in an unread state on the basis of a notification strategy on any piece of equipment to which notification or re-notification has been performed.

11. The information notification device according to claim 9,
wherein the function execution unit deletes notification information that has attained an already read state from any piece of equipment to which notification or re-notification has been performed.

12. The information notification device according to claim 9,
wherein, when notification information has attained a read state on any piece of equipment to which notification or re-notification has been performed, the function execution unit also sets an unread state on other pieces of equipment that have an unread state.

13. The information notification device according to claim 1,
wherein the function execution unit transmits first notification information when a user comes within a certain range of a destination, and transmits second notification information when a user gets close to a destination.

14. The information notification device according to claim 1,
wherein the function execution unit sets a piece of equipment that is used by a large number of people that is in the vicinity of a user, or a piece of equipment that is shared with users in the vicinity as a re-notification target of notification information in a case in which notification information that has been transmitted to a piece of equipment that a user owns is unread.

15. The information notification device according to claim 1,
wherein the function execution unit sets a piece of equipment that a companion owns as a re-notification target of notification information in a case in which notification information that has been transmitted to a piece of equipment that a user owns is unread.

16. An information notification method comprising:
managing a plurality of pieces of equipment which are in a vicinity of a user; and
executing transmission of notification information to any one of the plurality of pieces of equipment by determining a notification strategy that will perform notification of notification information to a user.

17. An information reception device comprising:
a data output unit; and
a function execution unit that outputs notification information that is received from an information notification device from the data output unit using a notification method that depends on characteristics of notification information or characteristics of the corresponding information reception device itself.

18. The information reception device according to claim 17, further comprising:
an action recognition unit that recognizes an action state of a user that owns the corresponding information reception device,
wherein the function execution unit outputs notification information from the data output unit using a notification method that corresponds to a recognition result of the action recognition unit.

19. The information reception device according to claim 17, further comprising:
a user recognition unit that recognizes a user that owns the corresponding information reception device or a user that is in a vicinity of the corresponding information reception device,
wherein the function execution unit outputs notification information from the data output unit using a notification method that depends on a recognition result of the user recognition unit.

20. An information reception method comprising:
receiving notification information from an information notification device; and
outputting notification information from the information reception device using a notification method that depends on characteristics of notification information or characteristics of the information reception device.
